(19) United States
(12) Patent Application Publication
(10) Pub. No.: US 2018/0328799 A1
(43) Pub. Date: Nov. 15, 2018

(54) COMPLEX DEVICE AND ELECTRONIC DEVICE COMPRISING SAME

(71) Applicant: MODA-INNOCHIPS CO., LTD., Ansan-Si, Gyeonggi-do (KR)

(72) Inventors: In Kil PARK, Seongnam-Si, Gyeonggi-Do (KR); Jun Ho JUNG, Siheung-Si, Gyeonggi-Do (KR)

(21) Appl. No.: 15/775,822

(22) PCT Filed: Nov. 11, 2016
(86) PCT No.: PCT/KR2016/013000

§ 371 Date: May 11, 2018

(30) Foreign Application Priority Data
Nov. 13, 2015 (KR) 10-2015-0159967
Nov. 16, 2015 (KR) 10-2015-0160636
Nov. 26, 2015 (KR) 10-2015-0166550
Nov. 10, 2016 (KR) 10-2016-0149325

(51) Int. Cl. G01L 1/14; G01L 5/00; G02F 1/1333; G06F 3/041; G06F 3/044; G06K 9/00

(52) U.S. Cl. CPC G01L 1/144; G01L 5/0038; G02F 1/133308; G06F 3/0418; G06F 2203/04103; G06F 3/0414; G06F 3/044; G06K 9/00006; G06F 3/0412

(57) ABSTRACT

The present disclosure provides a complex device and an electronic device provided with the same, the complex device comprising: a pressure sensor; and at least one functional part having a different function from the pressure sensor.

### TECHNICAL FIELD

The present disclosure relates to a complex device and electronic device having the same, and more particularly, to a complex device including a pressure sensor and an electronic device having the same.

### BACKGROUND ART

In order to operate electronic devices such as various mobile communication terminals, various types of input devices are being used. For example, input devices such as buttons, keys, and a touch screen panel are being used. A touch screen panel, that is, a touch input device detects the touch of a human body and enables an electronic device to be easily and simply operated by only a light touch. Therefore, the use thereof is being increased. For example, touch input devices are also used for operation of mobile communication terminals, home appliances, industrial devices, automobiles, and the like.

Touch input devices used for electronic devices, such as mobile communication terminals, may each be provided between a protective window and a liquid crystal display panel displaying an image. Accordingly, characters, symbols, and the like are displayed from a liquid crystal display panel through the window, and when a user touches the corresponding portion, a touch sensor determines the position of the touch and performs a specific processing according to a control flow.

The touch input devices each have a technical means which detects and recognizes touch or non-touch of a human body (finger) or a pen using the detection of human body current due to the touch or a change in pressure, temperature, or the like. In particular, pressure sensors, which detect touch or non-touch of the human body or a pen using a pressure change, have been spotlighted.

There are various types of pressure sensors, including a piezoelectric-type pressure sensor using a piezoelectric body and an electrostatic pressure sensor using electrostatic capacitance. The piezoelectric-type pressure sensor is implemented by using a piezoelectric body which has a predetermined thickness and formed by using piezoelectric ceramic powder. However, when the piezoelectric powder is used, there are limitations in that since piezoelectric performance is low, and an output value is thereby low, a sensing error occurs. In addition, there is a limitation in that a sensing error is caused by an irregular voltage output due to irregular mixing of piezoelectric powder. In addition, the piezoelectric body using piezoelectric ceramic powder has a limitation in that it is not easy to apply the piezoelectric body using the powder to various devices due to weakness in brittleness.

In addition, the electrostatic-type pressure sensor has a structure in which an air gap or a material such as silicone (or rubber) is provided between two electrodes. Such pressure sensors may detect the change in electrostatic capacitance according to the distance between two electrodes due to a touch pressure and thereby detect a pressure. However, when an air gap is formed, since the dielectric constant of air is 1, in order to sense the capacitance value due to the change in distance between two electrodes, a large amount of change in distance is necessary between the two electrodes, and since a silicone or a rubber material also generally has a dielectric constant of 4 or less, a large amount of change is necessary between the two electrodes.

Meanwhile, electronic devices may further include other components aside from pressure sensors. For example, a haptic device or the like which responds to user's touch input and feeds back may further be included. However, a haptic actuator, a pressure sensor, or the like is separately provided to an electronic device, and thereby occupies a larger area. Thus, it is difficult to follow the miniaturization trend of electronic devices.

### RELATED ART DOCUMENTS

Korean Patent Application Laid-open Publication No. 2014-0023440

Korean Patent Registration No. 10-1094165

### TECHNICAL PROBLEM

The present disclosure provides a pressure sensor capable of preventing a touch input error.

The present disclosure provides an electronic device provided with a pressure sensor capable of improving the brittleness.

The present disclosure provides a complex device and an electronic device in which a pressure sensor and pressure device, NFC, WPC, MST, and the like may be integrated.

### TECHNICAL SOLUTION

In accordance with an aspect of the present invention, a complex device includes a pressure sensor and at least one functional part having a different function from the pressure sensor.

The pressure sensor and the functioning part are formed by being stacked or are integrally formed.

The pressure sensor includes: first and second electrode layers provided spaced apart from each other and including first and second electrodes; and a piezoelectric layer or a dielectric layer provided between the first and second electrode layers.

The piezoelectric layer includes a plurality of plate-like piezoelectric bodies in a polymer.

The piezoelectric layer includes a plurality of cutaway portions formed with predetermined widths and depths.

The complex device may further include an elastic layer provided inside the cutaway portions.

The dielectric layer is compressible and restorable, includes at least one among a material with a hardness of 10 or less, a plurality of dielectric bodies with a dielectric constant of 4 or more, and a plurality of pores, and further includes a material for shielding and absorbing electromagnetic waves.

The dielectric layer includes the dielectric bodies which are formed in a content of 0.01% to 95% based on 100% of the dielectric layer.

The dielectric layer has a porosity of 1% to 95%.

The pores are formed in two or more sizes and at least one or more shapes.

The dielectric layer has a smaller pore cross-sectional area ratio in a vertical cross-section thereof than in a horizontal cross-section thereof.

The dielectric layer has at least one pore having a larger diameter in a horizontal direction than in a vertical direction.

The dielectric layer has a dielectric constant of 2 to 20.

The piezoelectric layer or the dielectric layer is formed in a thickness of 500 μm or less.

The complex device may further include an insulating layer provided on at least one among places on the first electrode layer, between the first and second electrode layers, and under the second electrode layer.

The complex device further includes first and second connection patterns respectively provided on the first and second electrode layers and connected to each other.

The pressure sensor enables the functional part.

The functional part includes: a piezoelectric device provided on one side of the pressure sensor; and a vibration plate provided on one side of the piezoelectric device.

The piezoelectric device is used as a piezoelectric vibration device or a piezoelectric acoustic device according to a signal applied thereto.

The functional part includes at least one among an NFC, a WPC, and an MST which are provided on one side of the pressure sensor and each of which includes at least one antenna pattern.

The functional part includes: a piezoelectric device provided on one surface of the pressure sensor; a vibration plate provided on one surface of the piezoelectric device; and at least one among an NFC, a WPC, and an MST which are provided on the other surface of the pressure sensor or on one surface of the vibration plate.

The complex device includes a fingerprint detection unit electrically connected to the pressure sensor and configured to measure, from the pressure sensor, a difference in acoustic impedance generated by an ultrasonic signal at valleys and ridges of the fingerprint and thereby detects the fingerprint.

In accordance with another aspect of the present invention, an electronic device includes: a window; a display part configured to display an image through the window; and a complex device in accordance with one aspect of the present invention.

The complex device includes at least any one of at least one first complex device provided under the display part and at least one second complex device provided under the window.

The complex device further includes a touch sensor provided between the window and the display part.

The complex device further includes a bracket provided on at least one among places on the first electrode layer, between the first and second electrode layers, and under the second electrode layer.

At least a portion of at least any one of the first and second electrode layers may be formed on the bracket.

### ADVANTAGEOUS EFFECTS

The pressure sensors in accordance with exemplary embodiments are each provided with a piezoelectric layer or a dielectric layer between first and second electrode layers spaced apart from each other. In addition, in an exemplary embodiment, a complex device may be implemented such that the pressure sensor is integrated with a predetermined functional part serving a different function from the pressure sensor. For example, the complex device may be implemented such that the pressure sensor is integrated with a piezoelectric device which functions as a piezoelectric acoustic device or a piezoelectric vibration device, or with an NFC, a WPC, or MST.

Thus, the area occupied by the devices may be reduced by applying the complex device to electronic devices compared to related arts in which at least two or more device are individually applied, and thus, it is possible to respond to miniaturization of electronic devices.

### BRIEF DESCRIPTION OF THE DRAWINGS

FIG. 1 is a cross-sectional view of a pressure sensor in accordance with a first exemplary embodiment;

FIGS. 2 and 4 are schematic plan views of first and second electrode layers of a pressure sensor in accordance with exemplary embodiments;

FIGS. 5 to 11 are cross-sectional views of pressure sensors in accordance with other exemplary embodiments;

FIG. 12 is a schematic plan view of first and second electrode layers of a pressure sensor in accordance with another exemplary embodiments;

FIGS. 13 to 15 are schematic cross-sectional views of a complex device in accordance with exemplary embodiments;

FIGS. 16 to 17 are an exploded perspective view and an assembled perspective view of a complex device in accordance with other exemplary embodiments;

FIGS. 18 and 19 are a front perspective view and a rear perspective view which are provided with a pressure sensor or a complex device including the pressure sensor in accordance with the first exemplary embodiment;

FIG. 20 is a partial cross-sectional view taken along line A-A′ of FIG. 18;

FIG. 21 is a cross-sectional view of an electronic device in accordance with a second exemplary embodiment;

FIG. 22 is a schematic planar view illustrating a disposition form of a pressure sensor of an electronic device in accordance with a second exemplary embodiment;

FIG. 23 is a schematic planar view illustrating a disposition form of a pressure sensor of an electronic device or a complex device in accordance with a third exemplary embodiment;

FIGS. 24 to 27 are control configuration diagrams for complex devices in accordance with exemplary embodiments;

FIG. 28 is a block diagram for describing a data processing method of a complex device in accordance with another exemplary embodiment;

FIG. 29 is a configuration diagram of a fingerprint recognition sensor employing a pressure sensor in accordance with exemplary embodiments; and

FIG. 30 is a cross-sectional view of a pressure sensor in accordance with another exemplary embodiment.

### DETAILED DESCRIPTION

Hereinafter, exemplary embodiments of the present invention will be described in detail with reference to the accompanying drawings. The present invention may, however, be embodied in different forms and should not be construed as limited to the embodiments set forth herein. Rather, these embodiments are provided so that this invention will be thorough and complete, and will fully convey the scope of the present invention to those skilled in the art.

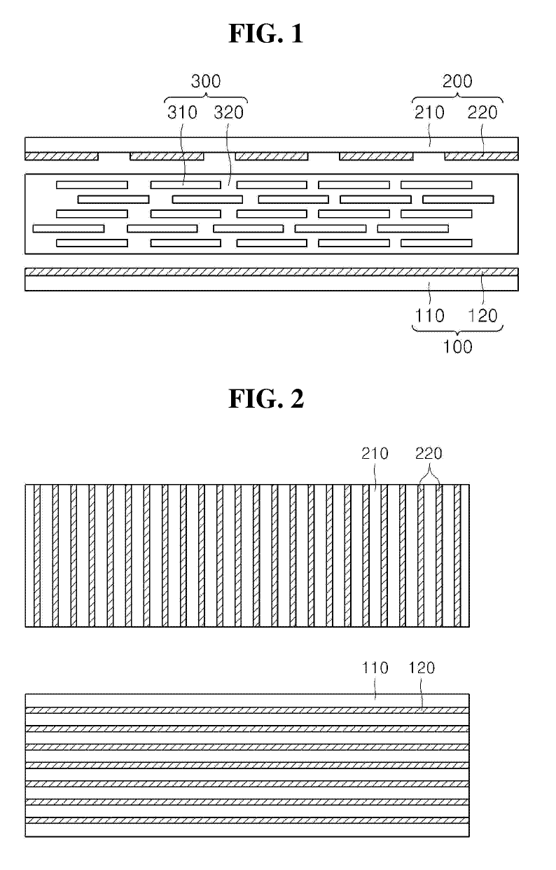

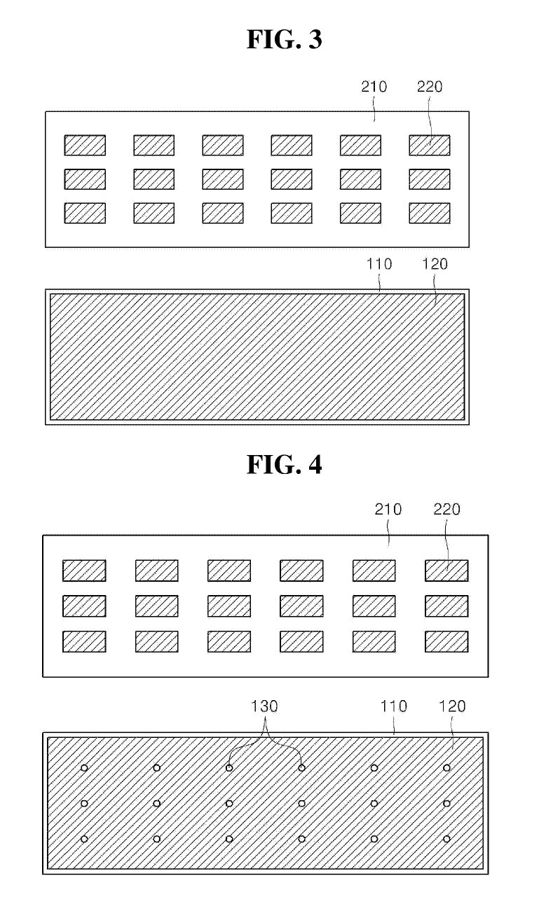

FIG. 1 is a cross-sectional view of a pressure sensor in accordance with a first exemplary embodiment, and FIGS. 2 and 4 are schematic views of first and second electrode layers.

Referring to FIG. 1, a pressure sensor in accordance with an exemplary embodiment includes: first and second electrode layers 100 and 200 which are spaced apart from each other; and a piezoelectric layer 300 provided between the first and second electrode layers 100 and 200. Here, the piezoelectric layer 300 may be provided with a plurality of plate-like piezoelectric bodies 310 having predetermined thicknesses.

1. Electrode Layer

The first and second electrode layers 100 and 200 are spaced apart from each other in the thickness direction (that is, in the vertical direction) and the piezoelectric layer 300 is provided therebetween. The first and second electrode layers 100 and 200 may include: first and second support layers 110 and 120; and first and second electrodes 120 and 220 which are respectively formed on the first and second support layers 110 and 210. That is, the first and second support layers 110 and 210 are formed to be spaced a predetermined distance apart from each other, and the first and second electrodes 120 and 220 are respectively formed on the surfaces of the first and second support layers 110 and 210. Here, the first and second electrodes 120 and 220 may be formed in directions facing each other, or may also be formed not facing each other. That is, the first and second electrodes 120 and 220 may be formed to face the piezoelectric layer 300, also be formed such that any one thereof faces the piezoelectric layer 300 and the other does not dace the piezoelectric layer 300, or may both be formed not facing the piezoelectric layer. At this point, the first and second electrodes 120 and 220 may be formed to be in contact with or also to be not in contact with the piezoelectric layer 300. For example, the pressure sensor in accordance with an exemplary embodiment may be implemented by the first support layer 110, the first electrode 120, the piezoelectric layer 300, the second electrode 220, and the second support layer 210 being stacked in the thickness direction from the bottom side. Here, the first and second support layers 110 and 210 support the first and second electrodes 120 and 220 so that the first and second electrodes 120 and 220 are respectively formed on one surface of the first and second support layers 110 and 210. To this end, the first and second support layers 110 and 210 may be provided in a plate shape having a predetermined thickness. In addition, the first and second support layers 110 and 210 may also be provided in a film shape so as to have flexible characteristic. Such first and second support layers 110 and 210 may be formed by using silicone, urethane, and polyurethane, polyimide, PET, PC, or the like. N addition, the first and second support layers 110 and 210 may be formed by using a prepolymer formed by using a liquid photocurable monomer, an oligomer, a photoinitiator, and additives. In addition, optionally, the first and second support layers 110 and 210 may be transparent or also be opaque. Meanwhile, a plurality of pores (not shown) may be provided in at least one of the first and second support layers 110 and 210. For example, the second support layer 210, the shape of which may be deformed by being bent downward due to a touch or press of an object, may include a plurality of pores. The pores may have sizes of 1 μm to 500 μm and be formed in a porosity of 10% to 95%. The plurality of pores are formed in the second support layer 210, and thus, the elastic force and restoring force of the second support layer 210 may be improved. At this point, when the porosity is 10% or less, the improvement of the elastic force and the restoring force may be insignificant, and when the porosity is greater than 95%, the shape of the second support layer 210 may not be maintained. Also, preferably, the support layers 110 and 220 having the plurality of pores do not have pores formed in the surface thereof. That is, when pores are formed in one surface on which the electrodes 120 and 220 are formed, the electrodes 120 and 220 may be disconnected or the thickness of the electrodes may increase. Therefore, preferably, pores are not formed in the one surface on which the electrodes 120 and 220 are formed.

The first and second electrodes 120 and 220 may be formed of a transparent conductive material such as an indium tin oxide (ITO) and an antimony tin oxide (ATO). However, aside from such materials, the first and second electrodes 120 and 220 may also be formed of another transparent conductive material, and also be formed of an opaque conductive material such as silver (Ag), platinum (Pt) and copper (Cu). Also, the first and second electrodes 120 and 220 may be formed in directions crossing each other. For example, the first electrode 120 may be formed in one direction so as to have a predetermined width, and further formed at intervals in other direction. The second electrode 220 may be formed in another direction perpendicular to the one direction so as to have a predetermined width, and further formed at intervals in the one direction perpendicular to the another direction. That is, as illustrated in FIG. 2, the first and second electrodes 120 and 220 may be formed in directions perpendicular to each other. For example, the first electrode 120 may be formed to have a predetermined width in the horizontal direction and further formed in plurality in the vertical direction to be arranged at intervals, and the second electrode 220 may be formed to have predetermined widths in the vertical direction and further formed in plurality in the horizontal direction to be arranged at intervals. Here, the widths of the first and second electrodes 120 and 220 may be equal to or greater than the respective intervals therebetween. Of course, the widths of the first and second electrodes 120 and 220 may also be smaller than the intervals therebetween, but preferably, the widths are larger than the intervals. For example, the ratio of the width to the interval in each of the first and second electrodes 120 and 220 may be 10:1 to 0.5:1. That is, when the interval is 1, the width may be 10 to 0.5. Also, the first and second electrodes 120 and 220 may be formed in various shapes aside from such a shape. For example, as illustrated in FIG. 3, any one of the first and second electrode 120 and 220 may entirely be formed on a support layer, and the other may also be formed in a plurality of approximately rectangular patterns having predetermined widths and spaced apart predetermined distances from each other in one direction and another direction. That is, a plurality of first electrodes 120 may be formed in approximately rectangular patterns, and the second electrode 220 may entirely be formed on the second support layer 210. Of course, aside from rectangles, various patterns such as circles and polygons may be used. In addition, any one of the first and second electrodes 120 and 220 may entirely be formed on a support layer, and the other may also be formed in a lattice shape which extends in one direction and another direction. Meanwhile, the first and second electrodes 120 and 220 may be formed in a thickness such as 0.1 μm to 500 μm, and the first and second electrodes 120 and 220 may be provided at intervals such as 1 μm to 10,000 μm. Here, the first and second electrodes 120 and 220 may be in contact with the piezoelectric layer 300. Of course, the first and second electrodes 120 and 220 maintain the states of being spaced a predetermined distance apart from the piezoelectric layer 300, and when a predetermined pressure, such as user's touch input, is applied, at least any one of the first and second electrodes 120 and 220 may locally be in contact with the piezoelectric layer 300. At this point, the piezoelectric layer 300 may also be compressed to a predetermined depth.

Meanwhile, a plurality of holes 130 (not shown) may be formed in at least any one of the first and second electrode layers 100 and 200. For example, as illustrated in FIG. 4, a plurality of holes 130 may be formed in the first electrode layer 100. That is, the plurality of holes 130 may be formed in the electrode layer used as a ground electrode. Of course, aside from the first electrode layer 100, the holes 130 may also be formed in the second electrode layer 200 used as a signal electrode and may also be formed in both the first and second electrode layers 100 and 200. In addition, the holes 130 may also be formed such that at least any one of the first and second electrodes 120 and 220 is removed and the first and second support layers 110 and 210 are exposed, and also be formed such that not only the first and second electrodes 120 and 220, but also the first and second support layers 110 and 210 are removed. That is, the holes 130 may also be formed such that the electrodes 120 and 220 are removed and the support layers 110 and 210 are thereby exposed, or also be formed so as to pass through the support layers 110 and 210 from the electrodes 120 and 220. Also, the holes 130 may be formed in a region in which the electrodes 120 and 220 overlap. For example, as illustrated in FIG. 4, the plurality of holes 130 may be formed in the first electrode 120 in the region overlapping the second electrode 220. Here, a single hole 130 may also be formed in the region overlapping the second electrode 220, and two or more holes may also be formed. Of course, as illustrated in FIG. 2, also in the case in which the first and second electrodes 120 and 220 are formed in one direction and another direction perpendicular to the one direction, the holes 130 may be formed in a region at which the first and second electrodes 120 and 220 cross each other. Due to the formation of the holes 130, the piezoelectric layer 300 may be more easily compressed. Such a hole 130 may be formed in a diameter such as 0.05 mm to 10 mm When the diameter of the hole 130 is less than 0.05 mm, the compression effect of the piezoelectric layer 300 may decrease, and when the diameter is greater than 10 mm, the restoring force of the piezoelectric layer 300 may decreased. However, the size of the hole 130 may be variously changed according to the size of a pressure sensor or an input device.

2. Piezoelectric Layer

The piezoelectric layer 300 is provided in a predetermined thickness between the first and second electrode layers 100 and 200, and may be provided in a thickness such as 10 μm to 5000 μm. That is, the piezoelectric layer 300 may be provided in various thicknesses according to the size of an electronic device in which a pressure sensor is adopted. For example, the piezoelectric layer 300 may be provided in a thickness of 10 μm to 5000 μm, preferably, less than 500 μm, and more preferably, equal to or less than 200 μm. The piezoelectric layer 300 may be formed by using a piezoelectric body 310, which has an approximately rectangular plate shape with a predetermined thickness, and a polymer 320. That is, a plurality of plate-like piezoelectric bodies 310 are provided in the polymer 320, whereby the piezoelectric layer 300 may be formed. Here, the piezoelectric body 310 may be formed by using a piezoelectric material based on PZT (Pb, Zr, Ti), NKN (Na, K, Nb), and BNT (Bi, Na, Ti). Of course, the piezoelectric body 310 may be formed of various piezoelectric materials, and may include: barium titanate, lead titanate, lead zirconate titanate, potassium niobate, lithium niobate, lithium tantalate, sodium tungstate, zinc oxide, potassium sodium niobate, bismuth ferrite, sodium niobate, bismuth titanate, or the like. However, the piezoelectric body 310 may be formed of a fluoride polymer or a copolymer thereof. The predetermined plate-like piezoelectric body 310 may be formed in an approximately rectangular plate shape which has predetermined lengths in one direction and another direction perpendicular to the one direction, and has a predetermined thickness. For example, the piezoelectric body 310 may be formed in a size of 3 μm to 5000 μm. The piezoelectric body 310 may be arranged in plurality in one direction and another direction. That is, the plurality of piezoelectric bodies may be arranged in the thickness direction (that is, in the vertical direction) between the first and second electrode layers 100 and 200 and a planar direction (that is, in the horizontal direction) perpendicular to the thickness direction. The piezoelectric bodies 310 may be arranged in a two or more layered structure, such as a five layered structure, in the thickness direction but the number of layers is not limited. In order to form the piezoelectric bodies 310 in a plurality of layers in the polymer 320, various methods may be used. For example, a piezoelectric body layer with a predetermined thickness may be formed on a polymer layer with a predetermined thickness, and the piezoelectric body layer is stacked in plurality, whereby the piezoelectric layer 300 may be formed. That is, the piezoelectric body layer is formed by disposing plate-like piezoelectric plates on a polymer layer which has a smaller thickness than the piezoelectric layer 300, and the piezoelectric layer 300 may be formed by stacking the plurality of piezoelectric body layers. However, the piezoelectric layer 300, in which the piezoelectric bodies 310 are formed in the polymer 320, may be formed through various methods. Meanwhile, preferably, the piezoelectric bodies 310 have the same size and are spaced the same distance apart from each other. However, the piezoelectric bodies 310 may also be provided in at least two or more sizes and two or more intervals. At this point, the piezoelectric bodies 310 may be formed with a density of 30% to 99%, and preferably provided in the same density in all regions. However, the piezoelectric bodies 310 may be provided such that at least one region thereof has a density of 60% or more. For example, when at least one region of the piezoelectric bodies 310 has a density 65% and at least another region has a density of 90%, a higher voltage may be generated in the region with the greater density. However, when a region has a density or 60% or more, a control unit may sufficiently sense the voltage generated in the piezoelectric layer. In addition, the piezoelectric bodies 310 in accordance with an exemplary embodiment have a superior piezoelectric characteristic because being formed in a single crystal form. That is, compared to a case of using typical piezoelectric powder, the plate-like piezoelectric bodies 310 are used, so that a superior piezoelectric characteristic may be obtained, and a pressure may thereby be detected even by a slight touch, and thus, an error in a touch input may be prevented. Meanwhile, the polymer 320 may include, but not limited to, at least one or more selected from the group consisting of epoxy, polyimide and liquid crystalline polymer (LCP). In addition, the polymer 320 may be formed of a thermoplastic resin. The thermoplastic resin may include, for example, one or more elected from the group consisting of novolac epoxy resin, phenoxy-type epoxy resin, BPA-type epoxy resin, BPF-type epoxy resin, hydrogenated BPA epoxy resin, dimer acid modified epoxy resin, urethane modified epoxy resin, rubber modified epoxy resin and DCPD-type epoxy resin.

3. Another Example of Piezoelectric Body

Meanwhile, the piezoelectric body 310 may be formed by using a piezoelectric ceramic sintered body which is formed by sintering a piezoelectric ceramic composition including a seed composition composed of: an orientation material composition composed of a piezoelectric material having a Perovskite crystalline structure; and an oxide which is distributed in the orientation material composition and has a general formula of ABO₃ (A is a bivalent metal element, and B is a tetravalent metal element). Here, the orientation material composition may be formed by using a composition, in which a material having a crystalline structure different from the Perovskite crystalline structure forms a solid solution. For example, a PZT-based material, in which PbTiO₃ (PT) having a tetragonal structure and PbZrO₃ (PZ) having a rhombohedral structure form a solid solution, may be used. In addition, in the orientation material composition, the characteristics of the PZT-based material may be improved by using a composition in which at least one of Pb(Ni,Nb)O₃ (PNN), Pb(Zn,Nb)O₃ (PZN) and Pb(Mn,Nb)O₃ (PMN) is solid-solutioned as a relaxor in the PZT-based material. For example, the orientation material composition may be formed by solid-solutioning, as a relaxor, a PZNN-based material having a high piezoelectric characteristic, a low dielectric constant, and sinterability, in a PZT-based material by using a PZN-based material and PNN-based material. The orientation material composition in which the PZNN-based material is solid-solutioned as a relaxor in the PZT-based material may have an empirical formula of (1−x)Pb(Zr_{0.47}Ti_{0.53})O₃−xPb((Ni_{1-y}Zn_{y})_{1/3}Nb_{2/3})O₃. Here, x may have a value in the range of 0.1<x<0.5, preferably, have a value in the range of 0.30≤x≤0.32, and most preferably, have a value of 0.31. In addition, y may have a value in the range of 0.1<y<0.9, preferably, have a value in the range of 0.39≤y≤0.41, and most preferably, have a value of 0.40. In addition, a lead-free piezoelectric material which does not contain lead (Pb) may also be used for the orientation material composition. Such a lead-free piezoelectric material may be a lead-free piezoelectric material which includes at least one selected from Bi_{0.5}K_{0.5}TiO₃, Bi_{0.5}Na_{0.5}TiO₃, K_{0.5}Na_{0.5}NbO₃, KNbO₃, NaNbO₃, BaTiO₃, (1−x)Bi_{0.5}Na_{0.5}TiO₃-xSrTiO₃, (1−x)Bi_{0.5}Na_{0.5}TiO₃-xB aTiO₃, (1−x)K_{0.5}Na_{0.5}NbO₃-xBi_{0.5}Na_{0.5}TiO₃, BaZr_{0.25}Ti_{0.75}O₃, etc.

The seed composition is composed of an oxide having a general formula ABO₃, and ABO₃ is an oxide having an orientable plate-like Perovskite structure, where A is composed of a bivalent metal element and B is composed a tetravalent metal element. The seed composition composed of an oxide having a general formula ABO₃ may include at least one among CaTiO₃, BaTiO₃, SrTiO₃, PbTiO₃ and Pb(Ti,Zr)O₃. Here, the seed composition may be included in a volume ratio of 1 vol % to 10 vol % based on the orientation material composition. When the seed composition is included in a volume ratio of less than 1 vol %, the effect of improving the crystal orientation is insignificant, and when included in a volume ratio greater than 10 vol %, the piezoelectric performance of the piezoelectric ceramic sintered body decreases.

As described above, the piezoelectric ceramic composition including the orientation material composition and the seed composition is grown while having the same orientation as the seed composition through a templated grain growth (TGG) method. That is, BaTiO3 is used as a seed composition in an orientation material composition having the empirical formula of 0.69Pb(Zr_{0.4}7Ti_{0.53})O₃-0.31Pb((Ni_{0.6}Zn_{0.4})_{1/3}Nb_{2/3})O₃, so that the piezoelectric ceramic sintered body not only can be sintered even at a low temperature of 1000° C. or less, but also has a high piezoelectric characteristic similar to a single crystal material because the crystal orientation is improved and the amount of displacement due to an electric field can be maximized.

The seed composition which improves the crystal orientation is added to the orientation material composition, and the resultant is sintered to manufacture the piezoelectric ceramic sintered body. Thus, the amount of displacement according to an electric field may be maximized and the piezoelectric characteristics may be remarkably improved.

As described above, in the pressure sensor in accordance with the first exemplary embodiment, the piezoelectric layer 300 is formed between the first and second electrode layers 100 and 200 which are spaced apart from each other, and the piezoelectric layer 300 may be provided with the plurality of single-crystal piezoelectric bodies 310 having predetermined plate-like shapes. Since the plate-like piezoelectric bodies 310 are used, the piezoelectric characteristics are better than that of typical piezoelectric powder. Thus, even a slight pressure may be easily sensed, and the sensing efficiency may thereby be improved.

That is, lead zirconatetita-nate (PZT) ceramic is being widely used for piezoelectric materials mainly used now. The PZT has been improved until now while being used for 80 years or more and is not further improved from the present level. In comparison, a material having an improved physical property is being demanded in fields in which piezoelectric materials are used. A single crystal is a material to meet such demand, and is a new material which can improve the performance of application elements by improving the physical property that has reached a limit by PZT ceramic. The single crystal may have a piezoelectric constant (d₃₃), which is more than two times greater than that of the polycrystal ceramic that is the main stream of typical piezoelectric material, and also have a large electromechanical coupling factor, and exhibit a superior piezoelectric characteristic.

As shown in Table 1 below, it can be found that a piezoelectric single crystal has much greater values of the piezoelectric constants (d₃₃ and d₃₁) and the electromechanical coupling factor (K33) than existing polycrystals. Such a superior physical property exhibits remarkable effects in applying the piezoelectric single crystal to an application device.

TABLE 1

| | polycrystal | single crystal |
|---|---|---|
| d33 [pC/N] | 160-338 | 500 |
| d31 [pC/N] | −50 | −280 |
| Strain [%] | ≈0.4 | ≈1.0 |

Therefore, compared to existing polycrystal ceramic, the piezoelectric single crystal is used for an ultrasonic vibrator in medical and nondestructive inspection, fish detection and the like to enable capturing of a clearer image, an ultrasonic vibrator in a washer or the like to enable stronger oscillation, and for a high-precision control actuator, such as a positioning device in a printer head and a HDD head, and a hand shaking prevention device, to enable more excellent responsibility and miniaturization.

Meanwhile, in order to manufacture a plate-like single crystal piezoelectric body, a solid single crystal growth method, the Bridgemann method, a salt fusion method, or the like may be used. After mixing a single-crystal piezoelectric body manufactured through such a method, the piezoelectric layer may be formed through a method such as printing and molding.

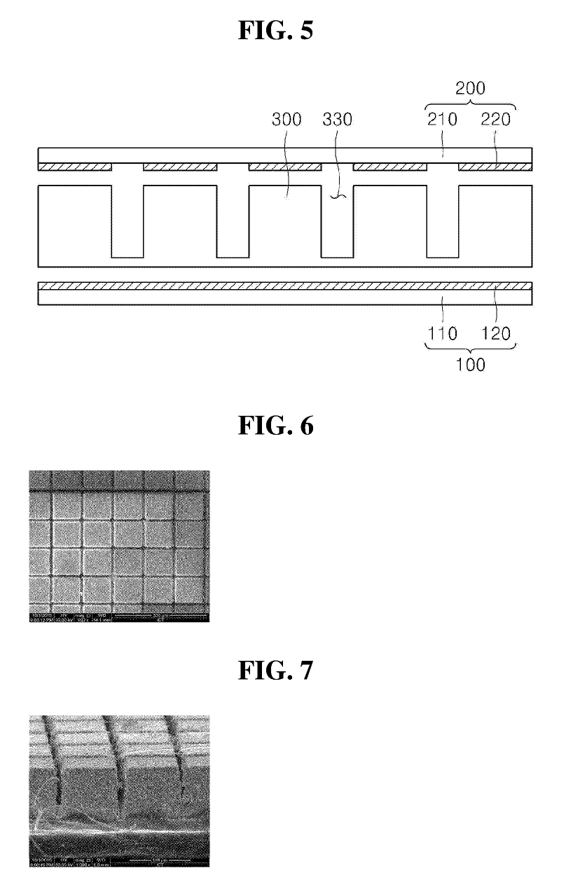

FIG. 5 is a cross-sectional view of a pressure sensor in accordance with a second exemplary embodiment. In addition, FIGS. 6 and 7 are planar and cross-sectional photographs of a pressure sensor in accordance with the second exemplary embodiment.

Referring to FIGS. 5 to 7, a pressure sensor in accordance with the second exemplary embodiment includes: first and second electrode layers 100 and 200 which are spaced apart from each other; and a piezoelectric layer 300 provided between the first and second electrode layers 100 and 200. At this point, the piezoelectric layer 300 may be formed of piezoelectric ceramic having a predetermined thickness. That is, in an exemplary embodiment, a piezoelectric layer 300 is formed such that plate-like piezoelectric bodies 310 are formed in the polymer 320, but in another exemplary embodiment, a piezoelectric layer 300 with a predetermined thickness may be formed by using piezoelectric ceramic. In addition, the same material as the piezoelectric body 310 may be used for the piezoelectric layer 300. Such a second exemplary embodiment will be described as follows while matters overlapping the descriptions of the first exemplary embodiment are omitted.

The piezoelectric layer 300 may be formed with predetermined widths and predetermined intervals in one direction and another direction facing the one direction. That is, the piezoelectric layer 300 may be divided into a plurality of unit cells with predetermined widths and predetermined intervals by cutaway portions 330 formed to predetermined depths. At this point, the cutaway portion 330 may include a plurality of first cutaway portions formed with predetermined widths in one direction, and a plurality of second cutaway portions formed with predetermined widths in another direction perpendicular to the one direction. Thus, the piezoelectric layer 300 may be divided into a plurality of unit cells having predetermined widths and predetermined intervals by a plurality of first and second cutaway portions as illustrated in FIGS. 5 and 6. At this point, the piezoelectric layer 300 may be cut away by the entire thickness may be cut, or by 50% to 95% of the entire thickness. That is, in the piezoelectric layer 300, the entire thickness is cut or 50% to 95% of the entire thickness is cut, whereby the cutaway portion may be formed. As such, the piezoelectric layer 300 is cut, whereby the piezoelectric layer 300 has a predetermined flexible characteristic. At this point, the piezoelectric layer 300 may be cut so as to have a size of 10 μm to 5,000 μm and intervals of 1 μm to 300 μm. That is, by means of the cutaway portion 330, a unit cell may have a size of 10 μm to 5,000 μm and an interval of 1 μm to 300 μm. Meanwhile, the first and second cutaway portions of the piezoelectric layer 300 may correspond to the intervals between the first and second electrodes 100 and 200. That is, the first cutaway portion may be formed to correspond to the intervals between the first electrodes of the first electrode layer 100, and the second cutaway portion may be formed to correspond to the intervals between the second electrodes of the second electrode layer 200. At this point, the intervals of the electrode layers and the intervals of the cutaway portions may be the same, or the intervals of the electrode layers may be greater than or smaller than the intervals of the cutaway portions. Meanwhile, the cutaway portions may be formed by cutting the piezoelectric layers 300 through a method, such as laser, dicing, blade cutting, or the like. In addition, the piezoelectric layer 300 may also be formed by forming cutaway portions by cutting a material at a green bar state through a method such as laser, dicing, blade cutting, or the like, and then performing a baking process.

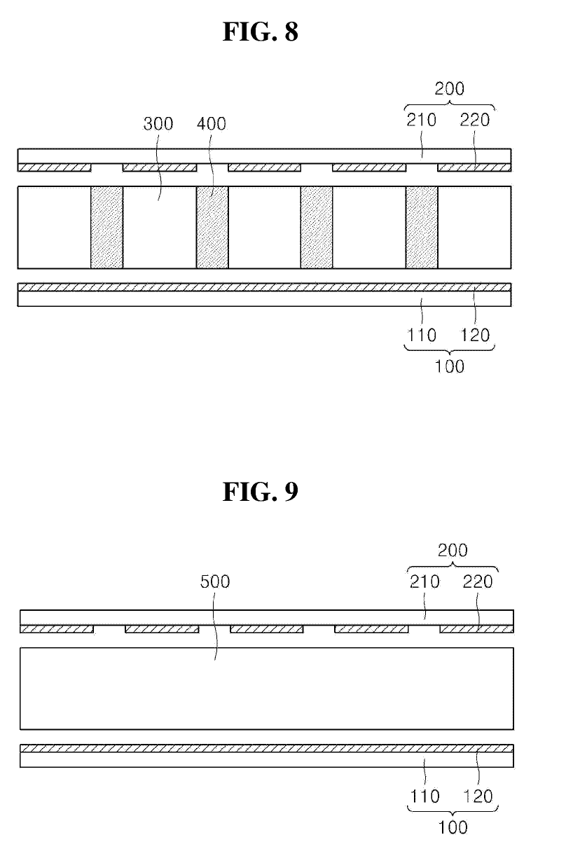

FIG. 8 is a cross-sectional view of a pressure sensor in accordance with a third exemplary embodiment.

Referring to FIG. 8, a pressure senor in accordance with the third exemplary embodiment may include: first and second electrode layers 100 and 200 which are spaced apart from each other; a piezoelectric layer 300 which is provided between the first and second electrode layers 100 and 200 and has a plurality of cutaway portions 330 formed therein in one direction and another direction; and an elastic layer 400 formed in the cutaway portions 330 of the piezoelectric layer 300. At this point, the cutaway portions 330 may be formed in the entire thickness of the piezoelectric layer 300 and formed in a predetermined thickness. That is the cutaway portions 330 may be formed in a thickness of 50% to 100% of the thickness of the piezoelectric layer 300. Accordingly, the piezoelectric layer 300 may be divided into unit cells spaced apart predetermined distances from each other in one direction and another direction by the cutaway portions 330, and the elastic layer 400 may be formed between the unit cells.

The elastic layer 400 may be formed by using a polymer, silicon, or the like which have elasticity. Since the piezoelectric layer 300 is cut and the elastic layer 400 is formed, the piezoelectric layer 300 may have a higher flexible characteristic than other exemplary embodiments in which the elastic layer 400 is not formed. That is, when the cutaway portions 330 are formed in the piezoelectric layer 300, but the elastic layer is not formed, the flexible characteristic of the piezoelectric layer 300 may be restricted. However, the piezoelectric layer 300 is entirely cut and the elastic layer 400 is formed, whereby the flexible characteristic may be improved in such a degree that the piezoelectric layer 300 can be rolled. Of course, the elastic layer 400 may be formed such that the cutaway portions 330 are not formed in the entire thickness of the piezoelectric layer 300, but as illustrated in FIGS. 5 to 7, the elastic layer 400 may be formed such that the cutaway portions 330 formed in a portion of the thickness are filled with the elastic parts 400.

Meanwhile, the pressure sensor in accordance with an exemplary embodiment may include an electrostatic-type pressure sensor besides the piezoelectric-type pressure sensor using the piezoelectric layer as described above. Such an electrostatic-type pressure sensor in accordance with an exemplary embodiment will be described as follows.

FIG. 9 is a cross-sectional view of a pressure sensor in accordance with a fourth exemplary embodiment.

Referring to FIG. 9, a pressure sensor in accordance with the fourth exemplary embodiment includes: first and second electrode parts 100 and 200 which are spaced apart from each other; and a dielectric layer 500 provided between the first and second electrode layers 100 and 200. At this point, the dielectric layer 500 may be compressed and restored, and be formed by using a material with a hardness of 10 or less. Meanwhile, since the first and second electrode layers 100 and 200 of a pressure sensor in accordance with the fourth exemplary embodiment are the same as that described in the first to third exemplary embodiments, detailed descriptions thereon will be omitted.

The dielectric layer 500 is provided in a predetermined thickness between the first and second electrode layers 100 and 200, and may be provided in a thickness such as 10 μm to 5,000 μm. That is, the dielectric layer 500 may be provided in various thicknesses according to the size of an electronic device in which a pressure sensor is adopted. For example, the dielectric layer 500 may be provided in a thickness of 10 μm to 5,000 μm, preferably, 500 μm or less, and more preferably, 200 μm or less. Such a dielectric layer 500 may be formed such that a space, that is, an air gap, is not formed therein. That is, when a space is formed inside the dielectric layer 500, foreign substances or moisture may penetrate into the space, and accordingly, the dielectric constant of the dielectric layer 500 is changed and a sensing value may thereby be affected. Therefore, in an exemplary embodiment, the dielectric layer 500 in which a space or the like are not formed may be used. In addition, a material the thickness of which may be changed due to a pressure change may be used for the dielectric layer 500. That is, a material which can be compressed and restored may be used for the dielectric layer 500. Such a dielectric layer 500 may be formed of a material with a hardness of 10 or less. For example, the dielectric layer 500 may have a hardness of 0.1 to 10, preferably a hardness of 2 to 10, and more preferably a hardness of 5 to 10. To this end, the dielectric layer 500 may be formed by using, for example, silicone, gel, rubber, urethane, or the like. Meanwhile, the dielectric layer 500 may further contain a material for shielding and absorbing electromagnetic waves. As such, the material for shielding and absorbing electromagnetic waves is further contained in the dielectric layer 500, whereby the electromagnetic wave may be shielded or absorbed. The material for shielding and absorbing electromagnetic waves may include ferrite, alumina, or the like, and may be contained in an amount of 0.01 wt % to 50 wt % in the dielectric layer 500. That is, based on 100 wt % of the materials constituting the dielectric layer 500, 0.01 wt % to 50 wt % of the material for shielding and absorbing electromagnetic waves may be contained. When the content of the material for shielding and absorbing electromagnetic waves is less than 1 wt %, the electromagnetic wave shielding and absorbing characteristic may be low, and when the content exceeds 50 wt %, the compression characteristic of the dielectric layer 500 may be decreased.

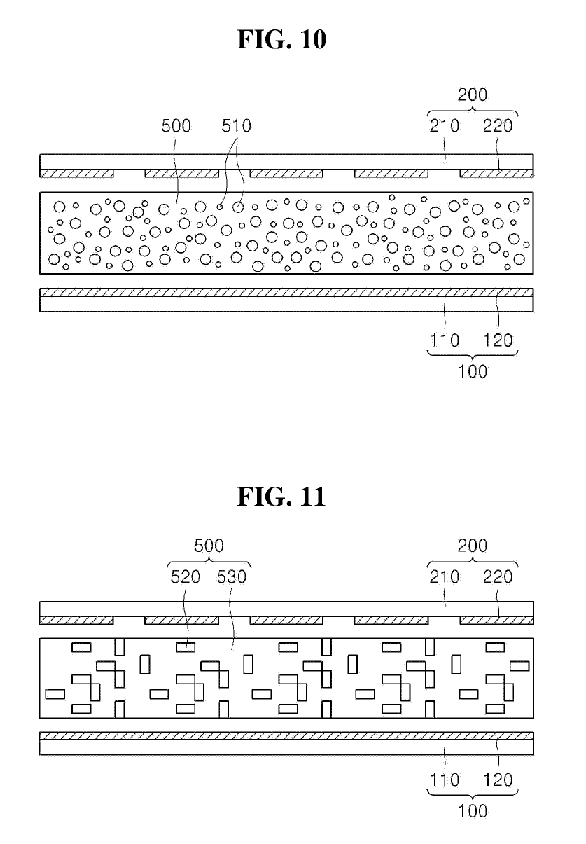

FIG. 10 is a cross-sectional view of a pressure sensor in accordance with a fifth exemplary embodiment.

Referring to FIG. 10, a pressure sensor in accordance with the first exemplary embodiment includes: first and second electrode parts 100 and 200 which are spaced apart from each other; and a dielectric layer 500 provided between the first and second electrode layers 100 and 200. At this point, the dielectric layer 500 may be compressed and restored, and be formed so as to have a plurality of pores 510.

The dielectric layer 500 may be compressed and restored, and be formed so as to have a plurality of pores 510. The pores 510 may be formed in sizes of 1 μm to 10,000 μm. Here, the sizes of the pores 510 may be the shortest diameter, be the longest diameter, or also be the average diameter thereof. Among these, the shorted diameter may be 1 μm to 500 μm. For example, the pores 510 may be formed in sizes of 1 μm to 10,000 μm, also be formed in sizes of 1 μm to 5,000 μm, and also be formed in sizes of 1 um to 1,000 μm. That is, the sizes of the pores 510 can be variously changed according to the size of a pressure sensor, the size of an electronic device in which the pressure sensor is adopted, the thickness and width of the dielectric layer 500, or the like. In addition, the pores 510 may be formed in the same size or sizes different from each other. For example, a dielectric layer 100 may be formed by mixing: first pores having an average size of 1 μm to 300 μm, second pores having an average size of 300 μm to 600 μm, and third pores having an average size of 600 μm to 1,000 μm. At this point, the first to third pores may also have a plurality of sizes. That is, the first to third pores may respectively have average sizes, and have a plurality of sizes within respective average sizes. As such, using pores 510 having a plurality of sizes, small pores may be formed between large pores, and thus, the porosity may further be improved. Such pores 510 may have various shapes. The cross-sectional shapes of the pores 310 may be formed in, for example, circles or ellipses, and at least a portion may also be formed in shapes extending toward one side. In addition, adjacent pores 510 may be at least partially connected to each other, and in this case, the pores 310 may also be formed in peanut shapes. In addition, at least any one pore 510 may have the horizontal diameter larger than the vertical diameter, for example, two times larger than the vertical diameter. Meanwhile, according to the thickness of the dielectric layer 500, the sizes of the pores 510 may be larger than the thickness of the dielectric layer 500. In this case, the pores 510 are formed in the thickness direction of the dielectric layer 500, and thus, a vacant region may be provided between the first and second electrode layers 100 and 200. However, when the sizes of the pores 510 increase and the vacant region is thereby provided in the dielectric layer 500, a compression force is weakened and a large sensing output may be obtained even with a small touch pressure. That is, a sensing margin may be improved. In addition, the pores 510 may be formed in a porosity of 1% to 95%. That is, the higher the porosity of the dielectric layer 500, the greater the dielectric layer 500 may be compressed even with a small touch pressure. However, when the porosity of the dielectric layer 500 is too high, the shape of the dielectric layer 500 is not easily maintained, and a portion of the dielectric layer 500 may also be collapsed. Thus, preferably, the plurality of pores 510 have a porosity of 1% to 95% such that the dielectric layer 500 may be compressed into a predetermined size at a predetermined pressure and a portion of the dielectric layer 300 may not be collapsed and maintain the shape thereof. At this point, the higher the porosity, the higher the sensitivity may be. Meanwhile, the porosity may be defined as (the ratio of arbitrary vertical cross-sectional area of pores within 1 cm²+the ratio of arbitrary horizontal cross-sectional area of pores within 1 cm²)/2. In addition, preferably, the dielectric layer 500 has the same porosity in all the regions thereof. However, the dielectric layer 500 may have at least one region the porosity of which is 10% or more. For example, when at least one region of the piezoelectric bodies 500 has a porosity of 10% and at least another region has a porosity of 80%, a larger value of change in electrostatic capacitance may be sensed in the region with the greater porosity. However, even when a region has a density of 10% or more, a control unit may sufficiently sense the value of change in electrostatic capacitance according to the density. In addition, in the dielectric layer 500, the cross-sectional area ratio of the pores 510 in vertical cross-sections may be smaller than that of the pores 510 in horizontal cross-sections. That is, in at least one region, preferably, in all regions in the dielectric layer 500, the ratio of the cross-sectional area of the pores 310 in the vertical direction may be smaller than the ratio of the cross-sectional area of the pores 310 in the horizontal direction.

Meanwhile, the dielectric layer 500 may be formed of a material, the thickness of which may be changed due to a pressure change. That is, the dielectric layer 500 may be formed of a material which can be compressed and restored. In addition, the dielectric layer 500 may be formed of a material containing the pores 510. For example, the dielectric layer 500 may be formed of a material, such as foamed rubber, foamed silicone, foamed latex, or foamed urethane, which contains pores 510 and can be compressed and restored. In addition, the dielectric layer 500 may be formed of a thermoplastic resin. The thermoplastic resin may include, for example, one or more elected from the group consisting of novolac epoxy resin, phenoxy-type epoxy resin, BPA-type epoxy resin, BPF-type epoxy resin, hydrogenated BPA epoxy resin, dimer acid modified epoxy resin, urethane modified epoxy resin, rubber modified epoxy resin and DCPD-type epoxy resin. Of course, the dielectric layer 500 may be formed of a material with a hardness of 10 or less. The dielectric layer 500 formed of such a material may have a dielectric constant of 2 to 20 inclusive. Meanwhile, the dielectric layer 300 in accordance with a fifth exemplary embodiment may further include a material for shielding and absorbing electromagnetic waves as the fourth exemplary embodiment. The material for shielding and absorbing electromagnetic waves may have a smaller size than the pores 510, and may thus be contained in the pores 510. Of course, the material for shielding and absorbing electromagnetic waves may have a size larger than the pores 510, and may thus be contained in a region in which the pores 510 of the dielectric layer 500 are not formed. Of course, the material for shielding and absorbing electromagnetic waves may have a smaller size than the pores 510, and may thus be contained in the dielectric layer 500 a region in which the pores 510 are not formed. Of course, the material for shielding and absorbing electromagnetic waves may have a plurality of sizes larger or smaller than the pores 510, and a portion thereof may thus be contained in the pores 510 or may be contained in the dielectric layer 500 in which the pores 510 are not formed.

FIG. 11 is a cross-sectional view of a pressure sensor in accordance with a sixth exemplary embodiment.

Referring to FIG. 11, a pressure sensor in accordance with the sixth exemplary embodiment includes: first and second electrode parts 100 and 200 which are spaced apart from each other; and a dielectric layer 500 provided between the first and second electrode layers 100 and 200. In this case, the dielectric layer 500 may be provided such that a dielectric body 520 having a higher dielectric constant than silicone or rubber, for example, a dielectric constant of 4 or more, preferably greater than 4 is mixed and provided in an insulating material 530, and accordingly, the dielectric layer 500 may have a dielectric constant of 4 or more, preferably, greater than 4. Meanwhile, the dielectric layer 500 may further include not only a dielectric body 520 but also the pores 510 described in the fifth exemplary embodiment.

The dielectric layer 500 may be formed such that the dielectric body 320 having a dielectric constant of 4 or more, preferably, greater than 4 and the insulating material 330 are mixed. That is, the dielectric layer 500 may be provided in a predetermined thickness such that the dielectric body 520 having a dielectric constant greater than 4 is provided in the insulating material 530. Accordingly, the dielectric layer 500 may have a dielectric constant of 4 or more. The dielectric body 520 may be added in a powder shape with a size such as 1 μm to 500 μm. At this point, one kind of powder or two or more kinds of powder which have a plurality of sizes may be used for the dielectric body 520. For example, a first dielectric body powder having an average particle diameter of 1 μm to 100 μm, a second dielectric body powder having an average particle diameter of 100 μm to 300 μm, and a third dielectric body powder having an average particle diameter of 300 μm to 500 μm, may be mixed and used. As such, as the dielectric powder having a plurality of sizes is used, small dielectric powder particles may be incorporated between large dielectric powder particles, and thus, the content of the dielectric powder may further be improved. Here, the first dielectric body powder may be smaller than or equal to the second dielectric body powder, and the second dielectric body powder may be smaller than or equal to the third dielectric body powder. That is, when the average particle diameter of the first dielectric body powder is A, the average particle diameter of the second dielectric body powder is B, and the average particle diameter of the third dielectric body powder is C, the ratio A:B:C may be 10-100:100-300:300-500. For example, the ratio A:B:C may be 10:100:300 and may be 100:200:500. In addition, the dielectric body 520 may have a larger predetermined shape than powder having sizes of 1 μm to 500 μm. For example, the dielectric body 520 may be added into an insulating material 330 in an approximately rectangular shape with a predetermined thickness. At this point, the plate-like dielectric body 520 may be provided in an approximately rectangular plate shape which has respectively predetermined lengths in the horizontal direction and another direction perpendicular thereto and has a predetermined thickness in the vertical direction. Such a rectangular plate-like dielectric body 520 may have size such as 3 μm to 5,000 μm. Preferably, the rectangular plate-like dielectric body 520 may have a length of 3 μm to 5,000 μm in at least one direction. At this point, the plate-like dielectric body 520 also may be composed of materials of a single kind, which have two or more sizes, or at least two or more kinds of materials. Of course, the dielectric body 520 may also be formed such that a powder-like first dielectric body having at least two or more sizes and a plate-like second dielectric body having at least two or more sizes are mixed. Meanwhile, the sizes of the dielectric body 520 may be larger than the thickness of the dielectric layer 500, and in this case, the dielectric body 520 may be provided in the horizontal direction, and may have a size larger than the thickness of the dielectric layer 500 in the horizontal direction.

A material having a dielectric constant of 4 or more, preferably, greater than 4, for example, a material including at least one among Ba, Ti, Nd, Bi, Zn, and Al, and for example, an oxide thereof may be used for the dielectric body 520. For example, the dielectric body 520 may include one or more among BaTiO₃, BaCO₃, TiO₂, Nd, Bi, Zn, and Al₂O₃. Meanwhile, the dielectric body 520 may be formed with a density of 0.01% to 95%. That is, the dielectric body 520 may be added in an amount of 0.01 to 95 with respect to 100 of the dielectric layer 310 in which the insulating material 530 and the dielectric body 520 are mixed. At this point, the higher the density of the dielectric body 520, the higher the dielectric constant of the dielectric layer 500. Therefore, preferably, the density of the dielectric body 520 is increased to a range in which the dielectric constant can be maximally increased. In addition, preferably, the dielectric layer 520 is prepared in the same density in all the regions thereof. However, the piezoelectric body 520 may be provided such that at least one region thereof has a density of 0.01% or more. For example, when at least one region of the dielectric bodies 520 has a density of 1% and at least another region has a density of 95%, a larger value of change in electrostatic capacitance may be sensed in the region with the greater density. However, even when a region has a density of 0.01% or more, a control unit may sufficiently sense the value of change in electrostatic capacitance according to the density.

A material, the thickness of which may be changed due to a pressure change, may be used for the insulating material 530. That is, a material which can be compressed and restored may be used for the insulating material 530. For example, the insulating material 330 may include, but not limited to, at least one or more selected from the group consisting of silicone, rubber, polymer, epoxy, polyimide and liquid crystalline polymer (LCP). In addition, the insulating material 530 has a hardness of 30 or less based on rubber, and foaming rubber, gel, phorone, urethane, or the like may be used for the insulating material 530. Here, the urethane which has a dielectric constant of 4 or more and can be compressed and restored, may also be independently used without containing the dielectric body 520, and may also further improve the dielectric constant by containing the dielectric body 520. Of course, the dielectric layer 500 may be formed of a material with a hardness of 10 or less, and for example, may be formed by using silicone, gel, rubber, urethane, or the like. In addition, the insulating material 530 may be formed of a thermoplastic resin. The thermoplastic resin may include, for example, one or more selected from the group consisting of novolac epoxy resin, phenoxy-type epoxy resin, BPA-type epoxy resin, BPF-type epoxy resin, hydrogenated BPA epoxy resin, dimer acid modified epoxy resin, urethane modified epoxy resin, rubber modified epoxy resin and DCPD-type epoxy resin. Of course, aside from the above materials, the material which can be used for the dielectric layer 500 described in the fourth and fifth exemplary embodiments may be used for the insulating material 530 in accordance with a sixth exemplary embodiment.

Meanwhile, the dielectric layer 500 may further contain a material for shielding and absorbing electromagnetic waves. The material for shielding and absorbing electromagnetic waves may have a size smaller than the dielectric body 520. Of course, the material for shielding and absorbing electromagnetic waves may have a size greater than the dielectric body 520. In addition, the material for shielding and absorbing electromagnetic waves may have a plurality of sizes larger or smaller than that of the dielectric body 520.

Meanwhile, as illustrated in FIG. 5, a pressure sensor in accordance with the fourth to sixth exemplary embodiment may have the cutaway portions 330 with a predetermined depth may be formed, and as illustrated in FIG. 8, the elastic layer 500 may be formed in the cutaway portions 330. Meanwhile, the cutaway portions 330 formed in the dielectric layer 500 may not only be formed by using a method such as laser, dicing, blade cut, but also be formed by using a mold frame.

As described above, the pressure sensor in accordance with the fourth exemplary embodiment does not have a spacer between the first and second electrode layers 100 and 200, and may have a dielectric layer 500 formed of a material with a hardness of 10 or less. Due to the formation of the spacer, penetration of foreign substances, moisture or the like may be prevented, and thus, the dielectric constant of the dielectric layer 500 is not changed and the change in a sensing value may thereby be prevented. In addition, in the pressure sensor in accordance with a fifth exemplary embodiment, the dielectric layer 500, which has the plurality of pores 310 between the first and second electrode layers 100 and 200 may be formed. That is, in the dielectric layer 500, the plurality of pores 510 having a porosity of 1% to 95% may be formed. In addition, in the pressure sensor in accordance with the sixth exemplary embodiment, the dielectric layer 500 may be formed between the first and second electrode layers 100 and 200 which are spaced apart from each other, and the dielectric layer 500 may be formed by mixing the dielectric body 520 having a dielectric constant of greater than 4, and the insulating material 530 which can be compressed and restored.

Accordingly, since an amount of change between the first and second electrodes increases even by a slight touch input, sufficient data may be obtained. Thus, the resolution is improved due to the amount of change in a capacitance value, whereby a pressure sensor, the data of which is easily processed, may be manufactured. In addition, since a large change in thickness is not necessary between the first and second electrode layers 100 and 200, the thickness thereof may be minimized, and thus, the thicknesses of the pressure sensor and the pressure sensor module may be reduced.

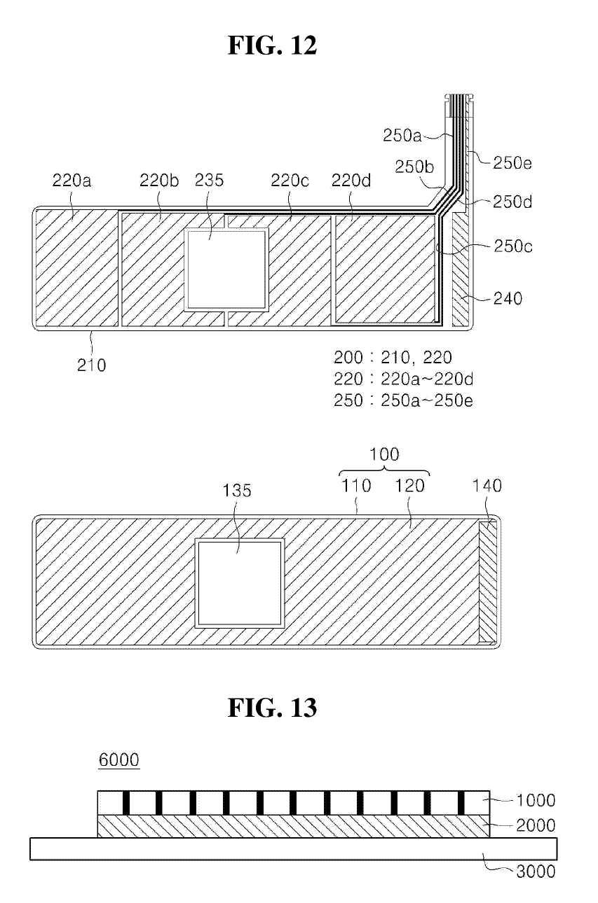

Meanwhile, the pressure sensor in accordance with an exemplary embodiment may have openings 135 and 235 on predetermined regions. That is, as illustrated in FIG. 12, first and second electrode layers 100 and 200 may be formed in predetermined shapes, and openings 135 and 235 may be formed in predetermined regions of the first and second electrode layers 100 and 200. The openings 135 and 235 may be provided such that another pressure sensor or a functional part having a different function from the pressure sensor may be inserted therethrough. At this point, although not shown, also in a piezoelectric layer 300 or a dielectric layer 500, openings overlapping the openings 135 and 235 formed in the first and second electrode layers 100 and 200 may be formed. Here, by using the pressure sensor, it is possible to enable another pressure sensor or a functional part inserted in the openings 130 and 230. That is, by using the pressure sensor, power may be applied to the another pressure sensor or the functioning part which are inserted into the openings 130 and 230. Alternatively, simultaneously with power applied to the pressure sensor by an application or hardware, or after a predetermined time, power may be applied to the another pressure sensor or the functioning part which are inserted into the openings 130 and 230. Meanwhile, the first and second electrodes 100 and 200 may also be formed in shapes different from each other. That is, as illustrated in FIG. 12, the first electrode layer 100 may have a first electrode 120 formed entirely on a first support layer 110, and the second electrode layer 200 may have a plurality of second electrodes 220 which are spaced a predetermined distance apart from each other on a second support layer 210. For example, the second electrodes 210 may be provided such that a first region 210a with an approximately rectangular shape, second and third regions 220b and 220c which have approximately rectangular shapes and are formed with the opening 230 therebetween, and a fourth region 220d formed in an approximately rectangular shape are spaced predetermined distances apart from each other. In addition, a first connection pattern 140 may be formed on the first support layer 110, and a second connection pattern 240 may be formed on the second support layer 210. At this point, the first connection pattern 140 is formed in contact with the first electrode 110, and the second connection pattern 240 is formed being spaced apart from the fourth region 220d. In addition, the first and second connection patterns 140 and 240 may be formed so as to partially overlapping each other. Of course, although not shown, a third connection pattern may be formed between the first and second connection patterns 140 and 240 on at least portion of the piezoelectric layer 300 or the dielectric layer 500 between the first and second electrode layers 100 and 200. That is, the third connection pattern may be formed being spaced apart from the piezoelectric layer 300 or the dielectric layer 500. Accordingly, the first and second connection patterns 140 and 240 may be connected through the third connection pattern. In addition, in the second electrode layer 200, first to fourth extending patterns 250a, 250b, 250c, and 250d may respectively be formed by extending from the first to fourth regions 210a to 210d, and a fifth extending pattern 250e may be formed by extending from the second connection pattern 240. The first to fifth extending patterns 250a to 250e may extend to a connector (not shown) and be connected to a control unit or power supply unit. Accordingly, a predetermined power supply such as a ground power supply may be applied to the first connection pattern 140 through the fifth extending pattern 250e, the second connection pattern 240, and the third connection pattern. In addition, the voltage sensed by the first to fourth regions 220a to 220d may be transferred to the connector through the first to fourth extending patterns 250a to 250d. Of course, a predetermined power supply such as a driving power supply may be applied to the first to fourth regions 220a to 220d through the first to fourth extending patterns 250a to 250d.

Meanwhile, the pressure sensor in accordance with exemplary embodiments may be provided as a complex device by being combined with a haptic device, a piezoelectric buzzer, a piezoelectric speaker, NFC, WPC, and magnetic secure transmission (MST), or the like. That is in a complex device in accordance with an exemplary embodiment, a pressure sensor and at least one functional part performing different function from the pressure sensor may be coupled or integrally formed. For example, as described in FIG. 13, a piezoelectric device 2000 may be formed on a vibration plate 3000, and a pressure sensor 1000 in accordance with exemplary embodiments may be provided above the piezoelectric device 2000. The pressure sensor 1000 may include a pressure sensor provided with the piezoelectric layer 300 or the dielectric layer 500 as described in the first to sixth exemplary embodiments. FIGS. 13 to 15 illustrate the structure described with FIG. 8. That is, FIGS. 13 to 15 illustrate a structure in which an elastic layer 4000 is formed inside the cutaway portions 330 formed in the piezoelectric layer 300 or the dielectric layer 500.

The piezoelectric device 2000 may be formed in a bimorph type having piezoelectric layers on both surfaces of a substrate, and may also be formed in a unimorph type having a piezoelectric layer on one surface of the substrate. At least one piezoelectric layer may be stacked and formed, and preferably, a plurality of piezoelectric layers may be stacked and formed. In addition, electrodes may respectively be formed on upper and lower portions of the piezoelectric layer. That is, the piezoelectric device 2000 may be implemented by stacking a plurality of piezoelectric layers and a plurality of electrodes alternately. Here, the piezoelectric layer 300 may be formed by using the same material as the piezoelectric layer 300, for example, a piezoelectric material based on PZT (Pb, Zr, Ti), NKN (Na, K, Nb), and BNT (Bi, Na, Ti). In addition, the piezoelectric layer may be stacked and formed by being polarized in directions different from each other or in the same direction. That is, when a plurality of piezoelectric layers are formed on one surface of the substrate, polarization may be alternately formed in directions different from each other or in the same direction in each piezoelectric layer. Meanwhile, for the substrate, a material having a characteristic of generating a vibration while maintaining the structure in which the piezoelectric layer is stacked, for example, metal, plastic, or the like may be used. Meanwhile, the piezoelectric device 2000 may have electrode pattern (not shown) in at least one region thereof to which a drive signal is applied. For example, the electrode pattern may be provided on an upper surface of the piezoelectric device 2000 or on edges of a lower surface of the piezoelectric device 2000. At least two electrode patterns may be formed being spaced apart from each other, may be connected to a connecting terminal (not shown), and may be connected to an electronic device through the connecting terminal. At this point, when the electrode pattern is formed on a lower portion of the piezoelectric device 2000, the electrode pattern may preferably be insulated from the vibration plate 3000, and to this end, an insulation film may be formed between the piezoelectric device 2000 and the vibration plate 3000.

The vibration plate 3000 may be provided so as to have the same shape as the piezoelectric device 2000 and the pressure sensor 1000, and may be provided larger than the piezoelectric device 2000. The piezoelectric device 2000 may be adhered with an adhesive on the upper surface of the vibration plate 3000. Metal or a polymer- or pulp-based material may be used for such a vibration plate 3000. For example, a resin film may be used for the vibration plate 3000, and a material having the young's modulus of 1 MPa to 10 GPa and a large loss coefficient, such as, an ethylene propylene rubber-based material and a styrene butadiene rubber-based material may be used. Such a vibration plate 3000 amplifies the vibration of the piezoelectric device 2000.

As such, the piezoelectric device 2000 provided between the vibration plate 3000 and the pressure sensor 1000 may be operated as a piezoelectric acoustic device or a piezoelectric vibration device according to a signal applied through an electronic device, that is, an alternating current power source. That is, the piezoelectric device 2000 may be used, according to an applied signal, as an actuator which generates a predetermined vibration, that is, as a haptic device, or may be used as a piezoelectric buzzer or a piezoelectric speaker which generates a predetermined sound.

Meanwhile, the piezoelectric sensor 1000 and the piezoelectric device 2000 may be adhered with an adhesive or the like, and may also be integrally formed. When the pressure sensor 1000 and the piezoelectric device 2000 are integrally manufactured, the pressure sensor 1000 can have a structure described by using FIGS. 5 and 8. That is, the second electrode may be formed on a portion in which a plurality of piezoelectric layers and electrodes are repeatedly stacked and on an upper portion thereof, and the piezoelectric layer 300 is formed on the second electrode, and the first electrode is formed on the piezoelectric layer. At this point, the second electrode is formed by patterning, the piezoelectric layer 300 may be cut into predetermined cell units by a plurality of cutaway portions, and the first electrode may be formed by patterning on the piezoelectric layer.

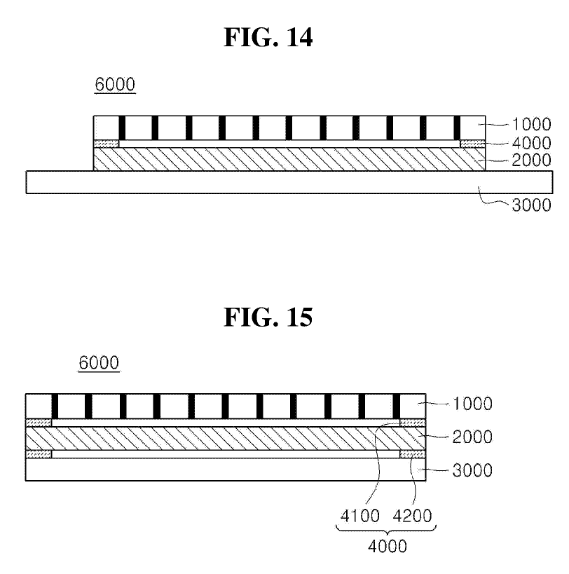

In addition, when the piezoelectric device 2000 is used as a piezoelectric buzzer or a piezoelectric speaker, preferably, a predetermined resonance space is provided between the piezoelectric device 2000 and the pressure sensor 1000. That is, as illustrated in FIG. 14, a support 4000 with a predetermined thickness may be provided on an edge between the piezoelectric device 2000 and the pressure sensor 1000. A polymer may be used for the support 4000. According to the height of the support 4000, the size of the resonance space between the piezoelectric device 2000 and the pressure sensor 1000 may be adjusted. Meanwhile, the support 4000 may also be implemented such that an adhesive tape or the like is provided along the periphery of the piezoelectric device 2000 and the pressure sensor 1000. In addition, as illustrated in FIG. 15, not only a first support 4100 may be formed on an edge between the piezoelectric device 2000 and the pressure sensor 1000, but also a second support 4200 may also be provided between piezoelectric device 2000 and the vibration plate 3000, whereby a predetermined resonance space may be provided.

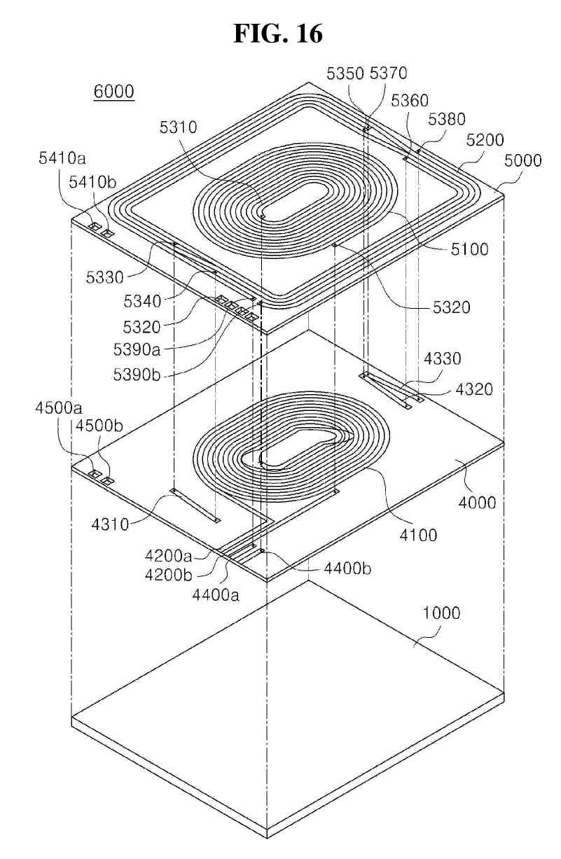

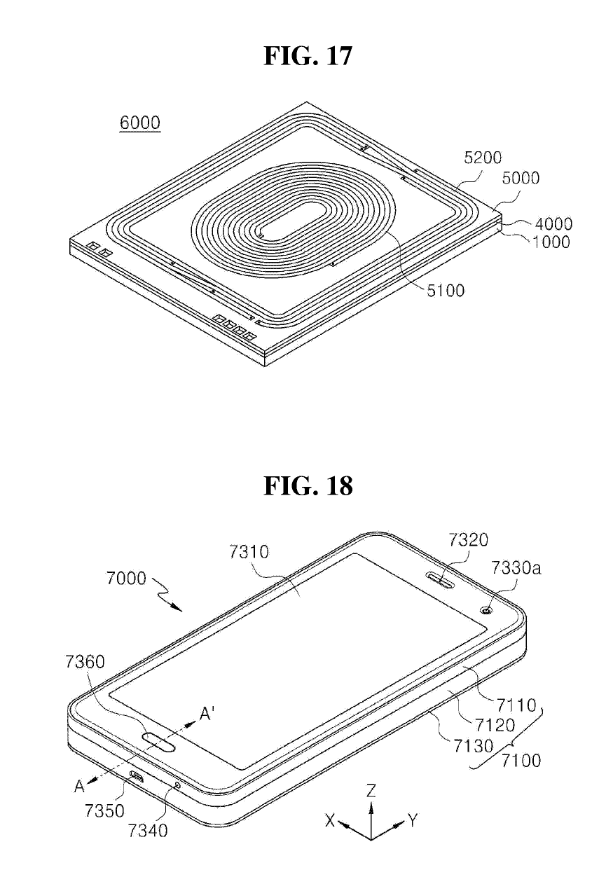

FIGS. 16 and 17 are an exploded perspective view and an assembled perspective view of a complex device including an NFC and a WPC as an example of a complex device including a pressure sensor in accordance with an exemplary embodiment. Of course, the pressure sensor may be coupled to each of an NFC, a WPC, and an MFC, and these NFC, WPC, and MST may be configured from predetermined antenna patterns.

Referring to FIGS. 16 and 17, a complex device may include: a first sheet 4000 which is provided on one surface of a pressure sensor 1000 and has a first antenna pattern 4100 formed thereon; and a second sheet 5000 which is provided on or under the first sheet 4000 or on the same surface as the first sheet 4000 and has a second antenna pattern 5100 and a third antenna pattern 5200 which are formed thereon. Here, the first antenna pattern 4100 of the first sheet 4000 and the second antenna pattern 5100 of the second sheet 5000 are connected to each other and thereby form a wireless power charge (WPC) antenna, and the third antenna pattern 5200 of the second sheet 5000 is formed outside the second antenna pattern 5100 and thereby forms a near field communication (NFC) antenna. That is, a complex device module in accordance with an exemplary embodiment may be provided by integrating a piezoelectric sensor, a WPC antenna, and an NFC antenna.

The first sheet 4000 is provided on one surface of the pressure sensor 1000 and has the first antenna pattern 4100 formed thereon. In addition, the first sheet 4000 is provide with: first and second extracting patterns 4200a and 4200b which are connected to the first antenna pattern 4100 and extracted to the outside; a plurality of connection patterns 4310, 4320 and 4330 which connect the third antenna pattern 5200 formed on the second sheet 5000; and third and fourth extracting patterns 4400a and 4400b which are connected to the third antenna pattern 5200 and extracted to the outside. Such a first sheet 4000 may be provided in the same shape as the pressure sensor 1000. That is, the first sheet 4000 may be provided in an approximately rectangular plate-shape. At this point, the thickness of the first sheet 4000 may be equal to or different from that of the pressure sensor 1000. The first antenna pattern 4100 may be formed in a predetermined number of turns, for example, by rotating in one direction from a central part of the first sheet 4000. For example, the first antenna pattern 4100 may be formed in a spiral shape which has a predetermined width and intervals and outwardly rotates counterclockwise. At this point, the wire widths and intervals of the first antenna pattern 4100 may be the same or different. That is, the first antenna pattern 4100 may have the wire widths greater than intervals. Also, the end of the first antenna pattern 4100 is connected to the first extracting pattern 4200a. The first extracting pattern 4200a is formed in a predetermined width and formed to be exposed toward one side of the first sheet 4000. For example, the first extracting pattern 4200a is formed to extend in the direction of the long-side of the first sheet 4000 and be exposed toward one short side of the first sheet 4000. In addition, the second extracting pattern 4200b is spaced apart from the first extracting pattern 4200a and is formed in the same direction as the first extracting pattern 4200a. Such a second extracting pattern 4200b is connected to the second antenna pattern 5100 formed on the second sheet 5000. Here, the second extracting pattern 4200b may be formed longer than the first extracting pattern 4200a. In addition, a plurality of connection patterns 4310, 4320 and 4330 are provided to connect the third antenna pattern 5200 formed on the second sheet 5000. That is, the third antenna pattern 5200 is formed in, for example, a semi-circular shape in which at least two regions are disconnected, and a plurality of connection patterns 4310, 4320, and 4330 are formed on the first sheet 4000 to connect the two regions to each other. The connection pattern 4310 is formed in a predetermined width and a predetermined length in the direction of one short side in a region between the first extracting patterns 4200a. The connection patterns 4320 and 4330 are formed on the position facing the connection pattern 4310 in the long-side direction, that is, on the other short side on which the first and second extraction patterns 4200a and 4200b are not formed, and are formed in predetermined widths and lengths on the other short side in the direction of the other short side without being exposed to the other short side. In addition, the connection patterns 4320 and 4330 are formed to be spaced apart from each other. In addition, the third and fourth extracting patterns 4400a and 4400b are formed to be spaced apart from the second extracting pattern 4200b, and formed to be exposed to the one short side. Meanwhile, through holes 4500a and 4500b are formed to be individually separated in the region in which the extracting patterns 4200 and 4400 of the one side on which the extracting patterns 4200 and 4400 are formed are not formed. In addition, the extracting patterns 4200 and 4400 are connected to the connection terminal (not shown) and connected to an electronic device through the terminal. Meanwhile, the first sheet 4000 may be manufactured by using magnetic ceramic. For example, the first sheet 4000 may be formed by using NiZnCu- or NiZn-based magnetic body. Specifically, in the NiZnCu-based magnetic sheet, Fe₂O₃, ZnO, NiO, CuO may be added as a magnetic body, and Fe₂O₃, ZnO, NiO, and CuO may be added in a ratio of 5:2:2:1. As such, the first sheet 4000 is manufactured by using magnetic ceramic, and thus, electromagnetic waves generated from the WPC antenna and the NFC antenna may be shielded or absorbed. Thus, the interference of the electromagnetic wave may be suppressed.

The second sheet 5000 is provided on the first sheet 5000, and the second antenna pattern 5100 and the third antenna pattern 5200 are formed to be spaced apart from each other. In addition, a plurality of holes 5310, 5320, 5330, 5340, 5350, 5360, 5370, and 5380 are formed in the second sheet 5000. Such a second sheet 5000 may be provided in the same shape as the pressure sensor 1000 and the first sheet 4000. That is, the second sheet 5000 may be provided in an approximately rectangular plate-shape. At this point, the thickness of the second sheet 5000 may be equal to or different from those of the pressure sensor 1000 and the first sheet 5000. That is, the second sheet 5000 may be provided in the smaller thickness than the pressure sensor 1000 and the same thickness as the first sheet 4000. The second antenna pattern 5100 may be formed in a predetermined number of turns, for example, by rotating in one direction from a central part of the second sheet 5000. For example, the second antenna pattern 5100 may be formed in a spiral shape which has a predetermined width and interval and outwardly rotates clockwise. That is, the second antenna pattern 5100 may be formed in a spiral shape rotating clockwise from the same region as the first antenna pattern 4100 formed on the first sheet 4000, and formed up to the region overlapping the second extraction pattern 4200b formed on the first sheet 4000. At this point, the wire width and the interval of the second antenna pattern 5100 may be the same as the wire width and the interval of the first antenna pattern 4100, and the second antenna pattern 5100 and the first antenna pattern 4100 may overlap. In the starting position and the end position of the second antenna pattern 5100, holes 5310 and 5320 are respectively formed, and the holes 5310 and 5320 are filled with a conductive material. Accordingly, the starting position of the second antenna pattern 5100 is connected to the starting position of the first antenna pattern 4100 through the hole 5310, and the end position of the second antenna pattern 5100 is connected to a predetermined region of the second extracting pattern 4200b through the hole 5320. The third antenna pattern 5200 is formed to be spaced apart from the second antenna pattern 5100 and is formed in a plurality of numbers of turns along the periphery of the second sheet 5000. That is, the third antenna pattern 5200 is provided to surround the second antenna pattern 5100 from the outside. At this point, the third antenna pattern 5200 is formed in a shape disconnected in a predetermined region on the second sheet 5000. That is, the third antenna pattern 5200 is not formed in a plurality of numbers of turns connected to each other, but may be formed in a shape disconnected in at least two regions and electrically disconnected from each other on the second sheet 5000. As such a plurality of holes 5330, 5340, 5350, 5360, 5370 and 5380 are formed between the third antenna patterns 5200 disconnected from each other. Also, the plurality of holes 5340, 5350, 5360, 5370, 5380 and 6380 are filled with a conductive material and respectively connected to the connection patterns 4310, 4320 and 4330 of the first sheet 4000. Accordingly, the third antenna pattern 5200 is formed in a shape disconnected in at least two regions, but may be electrically connected to each other through the plurality of holes 5330, 5340, 5350, 5360, 5370 and 5380 and the connection patterns 4310, 4320 and 4330 of the first sheet 4000. In addition, in the second sheet 5000, a plurality of through holes 5410 and 5420, which respectively expose the through holes 4500a and 4500b of the first sheet 4000 and the plurality of extracting patterns 4200 and 4400, are formed. In addition, the four through holes 5420 are formed so as to expose the plurality of, that is, four extracting patterns 4200 and 4400 of the first sheet 4000. Meanwhile, the second sheet 5000 may be manufactured by using a material different from that of the first sheet 4000. For example, the second sheet 5000 may be manufactured by using nonmagnetic ceramic, that is, manufactured by using low temperature co-fired ceramic (LTCC).

Meanwhile, the antenna patterns 4100, 5100 and 5200, extracting patterns 4200 and 4400, connection patterns 4310, 4320 and 4330, and the like are formed by using copper foils or a conductive paste, and when formed by using the conductive paste, the conductive paste may be printed on the sheet through various printing methods. As conductive particles of the conductive paste, metal particles of gold (Au), silver (Ag), nickel (Ni), copper (Cu), palladium (Pd), silver-coated copper (Ag coated Cu), silver-coated nickel (Ag coated Ni), nickel-coated copper (Ni coated Cu), and nickel-coated graphite (Ni coated graphite), carbon nanotubes, carbon black, graphite, silver-coated graphite (Ag coated graphite), or the like may be used. The conductive paste is a material, in which conductive particles are uniformly dispersed in a fluidic organic binder, is applied on a sheet through a method such as printing, and thereby exhibits electrical conductivity by heat treatment, such as, drying, cure, and baking. In addition, as a printing method, planography such as screen printing, roll-to-roll printing such as gravure printing, inkjet printing, or the like may be used.

As described above, the complex device module in accordance with an exemplary embodiment may be manufactured by integrating a pressure sensor, a WPC antenna, and an NFC antenna. Accordingly, by using one module, an input of an electronic device may be sensed by using one module, an electronic device may be wirelessly charged, and short-range communication can be performed. Of course, the complex device may also be manufactured such that a pressure sensor and at least one among a piezoelectric speaker, a piezoelectric actuator, a WPC antenna, an NFC antenna and an MST antenna are integrated. In addition, multiple functions are achieved with one module, and thus, compared to a case in which each of the functions is individually provided, the area of the region occupied in the case may be reduced.

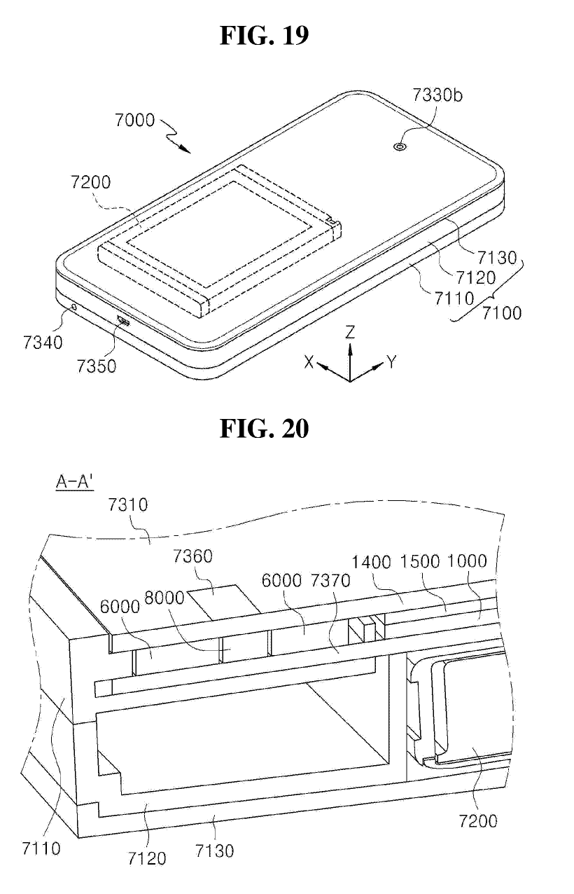

FIGS. 18 and 19 are a front perspective view and a rear perspective view of an electronic device provided with a pressure sensor in accordance with an exemplary embodiment, and FIG. 20 is a partial cross-sectional view taken along line A-A′ of FIG. 18. Here, the exemplary embodiment may be described using a mobile terminal including a smart phone as an example of an electronic device provided with a pressure sensor, and FIGS. 18 to 20 schematically illustrate main portions related to the exemplary embodiment.

Referring to FIGS. 18 to 20, an electronic device 7000 includes a case 7100 forming an outer appearance and a plurality of functional modules, circuits, and the like for performing a plurality of functions of the electronic device 7000 are provided inside the case 7100. The case 7100 may include a front case 7110, a rear case 7120, and a battery cover 7130. Here, the front case 7110 may form portions of the upper portion and the side surface of the electronic device 7000, and the rear case 7120 may form portions of the side surface and the lower portion of the electronic device 7000. That is, at least a portion of the front case 7110 and at least a portion of the rear case 7120 may form the side surface of the electronic device 7000, and a portion of the front case 7110 may form a portion of the upper surface except for a display part 7310. In addition, the battery cover 7130 may be provided to cover the battery 7200 provided on the rear case 7120. Meanwhile, the battery cover 7130 may be integrally provided or detachably provided. That is, when the battery 7200 is an integral type, the battery cover 7130 may be integrally formed, and when the battery 7200 is detachable, the battery cover 7130 may also be detachable. Of course, the front case 7110 and the rear case 7120 may also be integrally manufactured. That is, the case 7110 is formed such that the side surface and the rear surface are closed without distinction of the front case 7120 and the rear case 7130, and the battery cover 1130 may be provided to cover the rear surface of the case 7100. Such a case 7100 may have at least a portion formed through injection molding of a synthetic resin and may be formed of a metal material. That is, at least portions of the front case 7110 and the rear case 7120 may be formed of a metal material, and for example, a portion forming the side surface of the electronic device 7000 may be formed of a metal material. Of course, the battery cover 7130 may also be formed of a metal material. Metal materials used for the case 7100 may include, for example, stainless steel (STS), titanium (Ti), aluminum (Al) or the like. Meanwhile, in a space formed between the front case 7110 and the rear case 7120, various components, such as a display part such as a liquid crystal display device, a pressure sensor, a circuit board, a haptic device, may be incorporated.

In the front case 7110, a display part 7310, a sound output module 7130, a camera module 7330a, and the like may be disposed. In addition, on one surface of the front case 7110 and the rear case 7120, a microphone 7340, an interface 7350 and the like may be disposed. That is, on the upper surface of the electronic device 7000, the display part 7310, the sound output module 7130, the camera module 7330a and the like may be disposed, and on one side surface of the electronic device 7000, that is, on the lower side surface, the microphone 7340, the interface 7350, and the like may be disposed. The display part 7310 is disposed on the upper surface of the electronic device 7000 and occupies the most of the upper surface of the front case 7110. That is, the display part 7310 may be provided in an approximately rectangular shape respectively having predetermined lengths in X- and Y-directions, includes the central region of the upper surface of the electronic device 7000, and is formed on most of the upper surface of the electronic device 7000. At this point, between the outer contour of the electronic device 7000, that is, the outer contour of the front case 7110, and the display part 7310, a predetermined space which is not occupied by the display part 7310 is provided. In the X-direction, the sound output module 7310 and the camera module 7330a are provided above the display part 7130, and a user input part including a front surface input part 7360 may be provided below the display part 1310. In addition, between two edges of the display part 7310, which extend in the X-direction, and the periphery of the electronic device 7000, that is, between the display part 7310 and the electronic device 1000 in the Y-direction, a bezel region may be provided. Of course, a separate bezel region may not be provided, and the display part 7310 may be provided to extend up to the periphery of the electronic device 1000 in the Y-direction.

The display part 7310 may output visual information and receive touch information from a user. To this end, the display part 7310 may be provided with a touch input device. The touch input device may include: a window 1400 which covers the front surface of the terminal body; a display part 1500 such as a liquid crystal display device; and a pressure sensor 1000 with which touch or pressure information of a user is input in accordance with at least any one of the exemplary embodiments. In addition, instead of the pressure sensor 1000, a complex device 6000 provided with a pressure sensor 1000 may constitute the touch input device. In addition, the touch input device may further include a touch sensor provided between the window 1400 and the display part 1500. That is, the touch input device may include a touch sensor and a first pressure sensor 1000, and may include a complex device 6000 including a touch sensor and a pressure sensor 1000. For example, the touch sensor may be formed such that a plurality of electrodes are formed to be spaced apart from each other in one direction and another direction perpendicular to the one direction on a transparent plate with a predetermined thickness, and a dielectric layer is provided therebetween and may detect a touch input from the user. That is, the touch sensor may have the plurality of electrodes disposed, for example, in a lattice shape, and detect the electrostatic capacitance according to the distance between the electrodes due to the touch input of the user. Here, the touch sensor may detect coordinates in the horizontal direction of user's touch, that is, in the X- and Y-directions perpendicular each other, and the pressure sensor 1000 or the complex device 6000 may detect coordinates not only in the X-and Y-directions, but also in the vertical direction, that is, in the Z-direction. That is, the touch sensor and the pressure sensor 1000 or the complex device 6000 may simultaneously detect the horizontal coordinates, and the pressure sensor 1000 or the complex device 6000 may further detect the vertical coordinate. As such, the touch sensor and the pressure sensor 1000 or the complex device 6000 simultaneously detect the horizontal coordinates, and the pressure sensor 1000 or the complex device 6000 detect the vertical coordinate, whereby the touch coordinate of the user may be more precisely detected.

Meanwhile, in regions aside from the display part 7310 on the upper surface of the front case 7110, the sound output module 7130, the camera module 7330a, and the front input part 7360, and the like may be provided. At this point, the sound output module 7130 and the camera module 7330a may be provided above the display part 7310, and the user input part such as the front surface input part 7360 may be provided below the display part 7310. The front surface input part 7360 may be configured from a touch key, a push key, or the like, and a configuration is also possible by using a touch sensor or a pressure sensor without the front surface input part 7360. At this point, in an inner lower portion of the front input part 7360, that is, inside the case 7100 below the front input part 7360 in the Z-direction, a function module 3000 for functions of the front surface input part 7360 may be provided. That is, according to a driving method of the front surface input part 7360, a functional module which performs the functions of a touch key or a push key may be provided, and a touch sensor or a pressure sensor may be provided. In addition, the front input part 7360 may include a fingerprint recognition sensor. That is, the fingerprint of the user may be recognized through the front surface input part 7360 and whether the user is a legal user may be detected, and to this end, the function module 8000 may include a fingerprint recognition sensor. Meanwhile, on one and the other sides of the front surface input part 7360 in the Y-direction, complex devices 6000 including pressure sensors in accordance with exemplary embodiments may be provided. The complex devices 6000 are provided on both sides of the front input part 7360 as a user input part, so that a function of detecting the user's touch input and returning to the previous screen and a setting function for screen setting of the display part 7310 may be performed. At this point, the front surface input part 7360 using the fingerprint recognition sensor may perform not only the fingerprint recognition of a user but also the function of returning to the initial screen. Meanwhile, the complex device 6000 is provided with a haptic feedback device such as a piezoelectric vibration device, and thus may respond to the user's input or touch and give a feedback. That is, the complex device 6000 may detect the user's pressure or touch and provide a feedback responding thereto. Meanwhile, at least one or more complex device 6000 may be provided in a predetermined region besides the display part 7310 in the electronic device 7000. For example, the complex device 6000 may further be provided in an outside region of the sound output module 7310, an outside region of the front surface input part 7360, a bezel region, or the like.

Although not shown, on the side surface of the electronic device 7000, a power supply part and a side surface input part may further be provided. For example, the power supply part and the side input part may respectively be provided on two side surfaces facing each other in the Y-direction in the electronic device, and may also be provided on one side surface so as to be spaced apart from each other. The power supply part may be used when turning on or off the electronic device, and be used when enabling or disabling a screen. In addition, the side surface input part may be used to adjust the loudness or the like of a sound output from the sound output module 7130. At this point, the power source part and the side surface input part may be configured from a touch key, a push key, or the like, and also be configured from a pressure sensor 1000. That is, the electronic device in accordance with an exemplary embodiment may be provided with pressure sensors 1000 in a plurality of regions besides the display part 7310. For example, at least one pressure sensor may further be provided for detecting a pressure of sound output module 7130, the camera module 7330a, or the like on the upper side of the electronic device, controlling a pressure of the front surface input part 7360 on the lower side of the electronic device, controlling a pressure of the power supply part and side input part on the side surface of the electronic device.

Meanwhile, on a rear surface, that is, on the rear case 7120 of the electronic device 7000, as illustrated in FIG. 12, a camera module 7330b may further be mounted. The camera module 7330b may be a camera which has a capturing direction substantially opposite that of the camera module 7330a, and has pixels different from those of the camera module 7330a. A flash (not shown) may additionally be disposed adjacent to the camera module 1330b. In addition, although not shown, a fingerprint recognition sensor may be provided under the camera module 1330b. That is, the front surface input part 7360 is not provided with a fingerprint recognition sensor, and the fingerprint recognition sensor may also be provided on the rear surface of the electronic device 7000 rather than on the front surface input part 7360.

The battery 7200 may be provided between the rear case 7120 and the battery cover 1300, also be fixed, or also be detachably provided. At this point, the rear case 7120 may have a recessed region corresponding to a region in which the battery 7200 is inserted, and may be provided such that after the battery 7200 is mounted, the battery cover 7200 covers the battery 1200 and the rear case 7120.

In addition, as illustrated in FIG. 20, a bracket 7370 is provided inside the electronic device 1000 between the display part 7310 and the rear case 7130, and the window 1400, the display section 1500, and the pressure sensor 6000 or the complex device 6000 may be provided above the bracket 7370. That is, above the bracket 7370 of the display part 7310, a touch input device in accordance with an exemplary embodiment may be provided, and the bracket 7370 supports the touch input device. In addition, the bracket 7370 may extend to a region besides the display part 7310. That is, as illustrated in FIG. 20, the bracket 7360 may extend to a region in which the front surface input part 7360 and the like are formed. In addition, at least a portion of the bracket 7370 may be supported by a portion of the front case 7110. For example, the bracket 7370 extending outside the display part 7310 may be supported by an extension part extending from the front case 7110. In addition, a separation wall with a predetermined height may also be formed on the bracket 1370 in a boundary region between the display part 7310 and the outside thereof. Such a bracket 7370 may support the complex device 6000 and the functional module 8000 such as the fingerprint recognition sensor. In addition, although not shown, there may be provided, on the bracket 7370, a printed circuit board (PCB) or a flexible printed circuit board (FPCB) provided with at least one driving means for supplying power to the functional module 8000 such as the pressure sensors 1000, the complex device 6000 and the fingerprint recognition sensor, receiving signals output therefrom, and detecting the signals.

As described above, at least one pressure sensor or the complex device including the same in accordance with exemplary embodiments may be provided in a predetermined region in the electronic device. For example, as described above, the pressure sensor or the complex device may be provided respectively in the display part 7310 and a user input part, and also be provided in any one thereamong. However, at least one or more pressure sensors or the complex device including the same may be provided in a predetermined region in the electronic device. As such, various examples in accordance with exemplary embodiments in which pressure sensors and the complex device including the same may be provided in a plurality of regions will be described as follows.

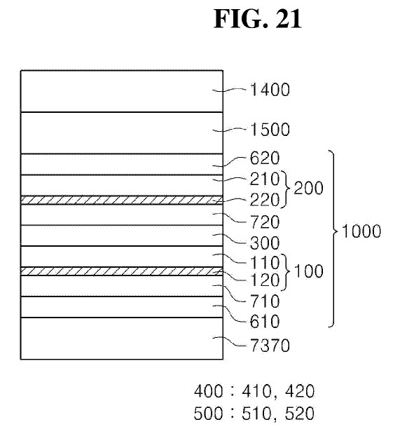

FIG. 21 is a cross-sectional view of an electronic device in accordance with a second exemplary embodiment, and is a cross-sectional view of a touch input device provided in the display part 7310. Here, the touch input device includes a pressure sensor 1000.

Referring to FIG. 21, an electronic device in accordance with the second exemplary embodiment includes a window 1400, a display section 1500, a pressure sensor 1000, and a bracket 7370.

The window 1400 is provided on the display section 1500 and is supported by at least a portion of a front case 1110. In addition, the window 1400 forms the upper surface of the electronic device and is to be in contact with an object such as a finger and a stylus pen. The window 1400 may be formed of a transparent material, for example, may be manufactured by using an acryl resin, glass, or the like. Meanwhile, the window 1400 may be formed not only on the display part 7310 but also on the upper surface of the electronic device 7000 outside the display part 7310. That is, the window 1400 may be formed so as to cover the upper surface of the electronic device 7000.

The display section 1500 displays an image to a user through the window 1400. The display section 1500 may include a liquid crystal display (LCD) panel, an organic light-emitting display (OLED) panel, or the like. When the display section 1500 is a liquid crystal display panel, a backlight unit (not shown) may be provided below the display section 1500. The backlight unit may include a reflective sheet, a light guide plate, an optical sheet, and a light source. A light-emitting diode (LED) may be used as the light source. At this point, the light source may be provided under an optical structure in which the reflective sheet, the light guide plate, and the optical sheet are stacked, or may also be provided on a side surface. A liquid crystal material of the liquid crystal display panel reacts with the light source of the backlight unit and outputs a character or an image in response to an input signal. Meanwhile, a light-blocking tape (not shown) is attached between the display section 1500 and the backlight unit and blocks the light leakage. The light-blocking tape may be configured in a form in which an adhesive is applied on both side surfaces of a polyethylene film. The display section 1500 and the backlight unit are adhered to the adhesive of the light-blocking tape, and the light from the backlight unit is prevented from leaking to the outside of the display section 1500 by the polyethylene film inserted in the light-blocking tape. Meanwhile, when the backlight unit is provided, the pressure sensor 1000 may also be provided under the backlight unit, and also be provided between the display section 1500 and the backlight unit.

The pressure sensor 1000 may include: first and second electrode layers 100 and 200; and a piezoelectric layer 300 provided between the first and second electrode layers 100 and 200. In addition, the pressure sensor 1000 may include a dielectric layer 500 provided between the first and second electrode layers 100 and 200. That is, FIG. 21 illustrates the pressure sensor 1000 in which the piezoelectric layer 300 is formed, but the pressure sensor 1000 may include the dielectric layer 500. The first and second electrode layers 100 and 200 may include: first and second support layers 110 and 210; and first and second electrodes 120 and 220 which are respectively formed on the first and second support layers 110 and 210 in various shapes. At this point, the first and second electrodes 120 and 220 may be provided so as to face each other with the piezoelectric layer 300 therebetween. However, as illustrated in FIG. 21, the first and second electrodes 120 and 220.may be formed such that any one thereof faces the piezoelectric layer 300 and the other does not face the piezoelectric layer 300. That is, the first electrode layer 100 may be formed such that the first electrode 120 is formed under a first support layer 110 and does not face the piezoelectric layer 300, and the second electrode layer 200 may be formed such that the second electrode 220 is formed under a second support layer 210 and faces the piezoelectric layer 300. In other words, upwardly from the bottom side, the first electrode 120, the first support layer 110, the piezoelectric layer 300, the second electrode 220, and the second support layer 210 are formed in this order. In addition, the pressure sensor 1000 may have adhesive layers 600 (610 and 620) on the lowermost layer and the uppermost layer. The adhesive layers 610 and 620 may be provided for adhering and fixing the pressure sensor 1000 between the display section 1500 and the bracket 7370. A double-sided adhesive tape, an adhesive tape, an adhesive, or the like may be used for the adhesive layers 610 and 620. In addition, a first insulating layer 710 may be provided between the first electrode layer 100 and the adhesive layer 610, and a second insulating layer 720 may be provided between the piezoelectric layer 300 and the second electrode 220. The insulating layers 700 (710 and 720) may be formed by using a material having an elastic force and a restoring force. For example, the insulating layers 710 and 720 may be formed by using silicone, rubber, gel, a teflon tape, urethane, or the like which has a hardness of 30 or less. In addition, a plurality of pores may be formed in the insulating layers 710 and 720. The pores may have sizes of 1 μm to 500 μm and be formed in a porosity of 10% to 95%. The plurality of pores are formed in the insulating layers 710 and 720, whereby the elastic force and the restoring force of the insulating layers 710 and 720 may further be improved. Here, the first and second support layers 110 and 210 may respectively be formed in thicknesses of 50 μm to 150 μm, the first and second electrodes 120 and 220 may respectively be formed in thicknesses of 1 μm to 500 μm, and the piezoelectric layer 300 or the dielectric layer 500 may be formed in a thickness of 10 μm to 5,000 μm. That is, the piezoelectric layer 300 or the dielectric layer 500 may be formed to be the same or thicker than the first and second electrode layers 100 and 200, and the first and second electrode layers 100 and 200 may be formed in the same thickness. However, the first and second electrode layers 100 and 200 may be formed in thicknesses different from each other. For example, the second electrode layer 200 may be formed in a smaller thickness than the first electrode layer 100. In addition, the first and second insulating layers 710 and 720 may respectively be formed in thicknesses of 3 μm to 500 μm, and the first and second adhesive layers 610 and 620 may respectively be formed in thicknesses of 3 μm to 1,000 μm. At this point, the first and second insulating layers 710 and 720 may be formed in the same thickness, and the first and second adhesive layers 610 and 620 may be formed in the same thickness. However, the insulating layers 710 and 720 are formed in thicknesses different from each other, and the first and second adhesive layers 610 and 620 may be formed in thicknesses different from each other. For example, the first adhesive layer 610 may be formed thicker than the second adhesive layer 620.

As illustrated in FIG. 20, the bracket 7370 is provided over the rear case 7120. The bracket 7370 supports the touch sensor, the display section 1500, and the pressure sensor 1000 or the complex device including the pressure sensor, which are provided over the bracket, and prevents the pressing force of an object from being scattered. Such a bracket 7370 may be formed of a material the shape of which is not deformed. That is, the bracket 7370 prevents the scattering of the pressing force of an object, and supports the touch sensor, the display section 1500, and the pressure sensor 1000 or the complex device 6000, and may therefore be formed of a material the shape of which is not deformed by a pressure. At this point, the bracket 7370 may be formed of a conductive material or an insulating material. In addition, the bracket 7370 may be formed in a structure in which an edge or the entire portion thereof is bent, that is, in a bent structure. As such, by providing the bracket 7370, the pressing force of an object is not scattered but concentrated, and thus, a touch region may be more precisely detected.

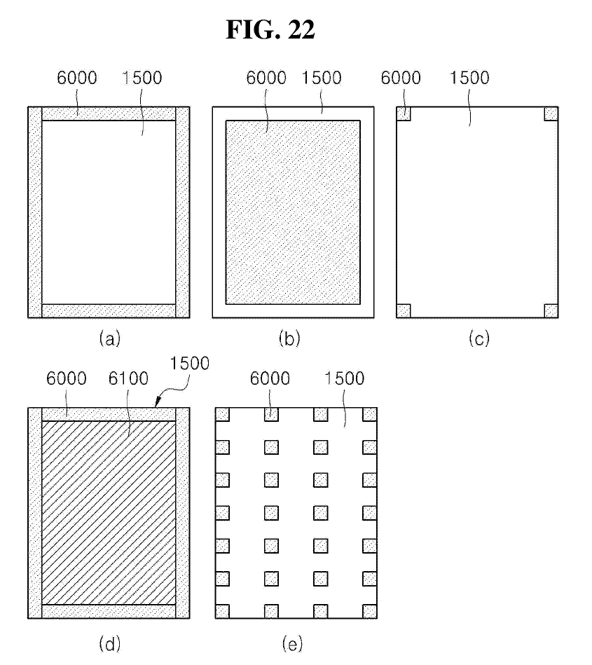

Meanwhile, the complex device 6000 may be formed on the entire region under the display section 1500 and may also be formed on at least a portion under the display section 1500. Such a disposition form of the complex device is illustrated in FIG. 22. FIG. 22 is a schematic plan view illustrating a disposition form of a complex device in an electronic device in accordance with a second exemplary embodiment, and illustrates a disposition form of a complex device 6000 with respect to the display section 1500.

As illustrated in (a) of FIG. 22, the complex device 6000 may be provided along the periphery of the display section 1500. At this point, the complex device 6000 may be provided in a predetermined width from the periphery, that is, from the edge, of the approximately rectangular display section 1500, and in a predetermined length. That is, the complex device 6000 with a predetermined width may be provided along two long sides of the display section 1500, and the complex device 6000 with a predetermined width may be provided along two short sides of the display section 2200. Accordingly, four complex devices 6000 may be provided along the periphery of the display section 1500, or one complex device 6000 may also be provided along the shape of the periphery of the display section 1500.

As illustrated in (b) of FIG. 22, the complex device 6000 may be provided in regions except for a predetermined width of the periphery of the display section 1500.

As illustrated in (c) of FIG. 22, the complex device 6000 may be provided in regions at which two adjacent sides of the display section 1500 meet, that is, in corner regions. That is, the complex device 6000 may be provided in four corner regions of the display section 1500.

As illustrated in (d) of FIG. 22, the complex device 6000 are provided in the peripheral regions of the display section 1500, and a filling member 6100 such as a double-sided tape may be provided in the remaining regions in which the complex device 6000 are not provided.

As illustrated in (a) of FIG. 22, a plurality of complex device 6000 may be provided at approximately regular intervals under the display section 1500.

Of course, in (a), (c), and (d) of FIG. 22, the filling member 6100 such as a double-sided tape may be provided in regions in which the complex device 6000 is not provided.

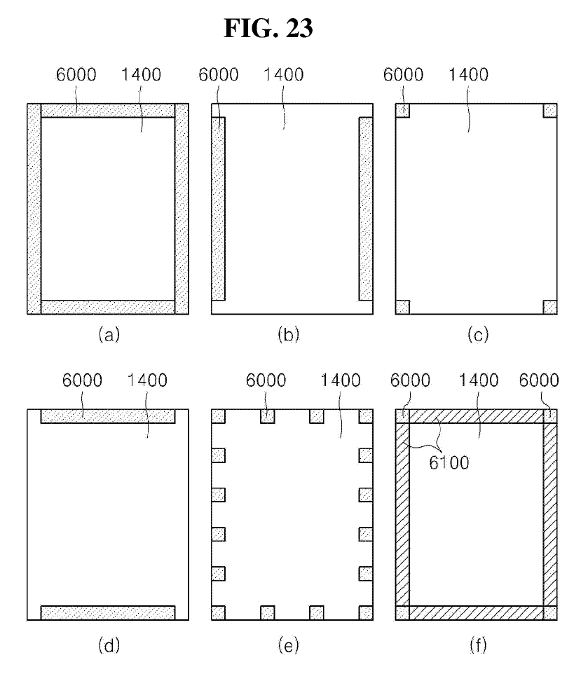

In addition, the complex device 6000 may also be provided in a region besides the display part 7310. In this case, at least one complex device 6000 may be provided in a region besides the display part 7310, and such a disposition form of the complex device 6000 is illustrated in FIG. 23. FIG. 23 is a schematic plan view illustrating a disposition form of a complex device 6000 in an electronic device in accordance with a third exemplary embodiment, and illustrates a disposition form of the complex device 6000 with respect to a window 1400.

As illustrated in (a) of FIG. 23, the complex device 6000 may be provided along the periphery of the window 1400. At this point, the complex device 6000 may be provided in a predetermined width from the periphery, that is, from the edge, of the approximately rectangular display section 1400, and in a predetermined length. That is, the complex device 6000 with a predetermined width may be provided along two long sides of the window 1400, and the complex device 6000 with a predetermined width may be provided along two short sides of the window 1400. In other words, the complex devices 6000 may be provided in a region other than the display part 7310, that is, in lower and upper-side regions of the display part 7310 and in a bezel region. At this point, four complex devices 6000 may be provided along the periphery of the window 1400, or one pressure sensor may also be provided along the shape of the periphery of the window 1400.

As illustrated in (b) of FIG. 23, the complex devices 6000 may be provided along the long-side edges of the window 1400. That is, the complex devices 6000 may be provided in a region between the edges of the display part 7310 and the periphery of an electronic device 7000, that is, in a bezel region.

As illustrated in (c) of FIG. 23, the complex devices 6000 may be provided in regions at which two adjacent sides of the display section 1400 meet, that is, in corner regions. That is, the complex devices 6000 may be provided in four corner regions of the display section 1400.

As illustrated in (d) of FIG. 23, the complex devices 6000 may be provided along the short-side edges of the window 1400.

As illustrated in (e) of FIG. 23, a plurality of complex devices 6000 may be provided on short-side and long-side edges of the window 1400 so as to be spaced a predetermined distance apart from each other. At this point, the plurality of complex devices 6000 may be provided at approximately regular intervals.

As illustrated in (f) of FIG. 23, complex devices 6000 may be respectively provided on four corner regions of the window 1400, and filling members 6100 such as adhesive tapes are provided in regions between the complex devices 6000, that is, in long-side and short-side edge regions.

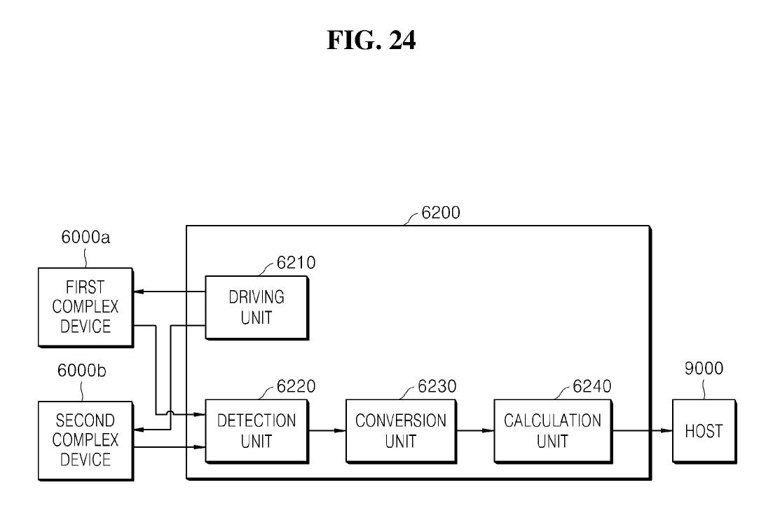

FIG. 24 is a control configuration diagram of a complex device in accordance with an exemplary embodiment, and is a control configuration diagram of first and second complex devices 6000a and 6000b respectively including pressure sensors 2300 and 2400 That is, FIG. 24 is a control configuration diagrams of first and second pressure sensors respectively included in the first and second complex devices 6000a and 6000b.

Referring to FIG. 24, the control configuration of a complex device in accordance with an exemplary embodiment may include a control unit 6200 which controls the operation of at least any one of first and second pressure sensors respectively included in the first and second complex devices 6000a and 6000b. The control unit 6200 may include a driving unit 6210, a detection unit 6220, a conversion unit 6230, and a calculation unit 6240. At this point, the control unit 6210 including the driving unit 6220, the detection unit 6230, the conversion unit 6240, and the calculation unit 2540 may be provided as one integrated circuit (IC). Accordingly, the output of at least one pressure sensor 1000 inside at least one complex device 6000 may be processed by using the one integrated circuit (IC).

The driving unit 6210 applies a driving signal to the at least one pressure sensor 1000 inside the at least one complex device 6000. That is, the driving unit 6210 may apply a driving signal to the first complex device 6000a and the second complex device 6000b, or apply a driving signal to the first complex device 6000a or the second complex device 6000b. To this end, the driving unit 6210 may include: a first driving unit for driving the first complex device 6000a; and a second driving unit for driving the second complex device 6000b. However, the driving unit 6210 may be configured as one unit and may apply a driving signal to the first and second complex devices 6000a and 6000b. That is, the single driving unit 6210 may apply a driving signal to each of the first and second complex devices 6000a and 6000b. When the complex device 6000 is provided in plurality, or the pressure sensor 1000 inside the complex device 6000 is provided in plurality, the driving unit 6210 may apply a driving signal to the pressure sensor 1000. In addition, the driving signal from the driving unit 6210 may be applied to any one of the first and second electrodes 120 and 220 constituting the first and second pressure sensors 1000. For example, the driving unit 6210 may also apply a predetermined driving signal to the second electrode 220. At this point, the driving signals applied to plurality of pressure sensors 1000 may be the same as or different from each other. The driving signal may be a square wave, a sine wave, a triangle wave, or the like which has predetermined period and amplitude, and may be sequentially applied to each of the plurality of first electrodes 220. Of course, the driving unit 6210 may apply a driving signal simultaneously to the plurality of first electrodes 120 or also selectively apply the driving signal to only a portion among the plurality of first electrodes 120.

The detection unit 6220 detects the signal output from the pressure sensor 1000. That is, the detection unit 6220 detects electrostatic capacitance from the plurality of first electrodes 120 of the electrostatic-type pressure sensor 1000. When a predetermined signal is applied to the second electrode 220, and a ground potential is applied to the first electrode 120 facing the second electrode, all the distance between the first and second electrodes 120 and 220 are the same and thereby have the same electrostatic capacitance. However, when the distance between the first and second electrodes 120 and 220 decreases by user's touch in at least one region, the electrostatic capacitance between the first and second electrodes becomes larger than in other regions. Accordingly, the detection unit 6220 detects a change in the electrostatic capacitance between the first and second electrodes 120 and 220 of the pressure sensors 1000, and thereby detects an input. Meanwhile, in case of a piezoelectric pressure sensor 1000, a pressure due to user's pressure or touch is transferred to a piezoelectric layer 300 through the second electrode 220, and thus, predetermined power may be generated from the piezoelectric layer 300, and the detection unit 6220 detects the power. Meanwhile, the detection unit 6220 may include first and second detection units for detecting the electrostatic capacitance or power of the plurality of pressure sensors 1000. However, a single detection unit 2220 may detect the electrostatic capacitance or power of all the plurality of pressure sensors 1000, and to this end, the detection unit 2220 may detect the electrostatic capacitance or power of the plurality of pressure sensors 1000. As such, the detection unit 6220 may detect the electrostatic capacitance or the power of the pressure sensors 1000 and detect a touched region and the pressure of the region. For example, when a user touches with a finger, the center of the finger touches a region, and thus, there may be a central region to which the highest pressure is transferred and a peripheral region to which a pressure smaller than the highest pressure is transferred. The central region receives the largest touch pressure of a user, and thus, the distance between the first and second electrodes is small, and in the peripheral region, the distance between the first and second electrodes increases, and thus, the electrostatic capacitance of the central region is greater than that of the peripheral region. In addition, in case of the piezoelectric pressure sensor, the pressure in the central region is higher than that in the peripheral region, and thus, greater power may be generated in the central region than in the peripheral region. Accordingly, by detecting and comparing the electrostatic capacitance or the power from a plurality of regions, the central region to which the highest pressure is transferred, and the peripheral region to which a pressure smaller than the highest pressure is transferred may be detected, and consequently, a region to be touched by the user may be determined and detected as the central region. Of course, the region which has not been touched by the user has lower initial electrostatic capacitance or power than the peripheral region. Meanwhile, such a detection unit 6220 may include a plurality of C-V converters (not shown) provided with at least one calculation amplifier and at least one capacitor, and the plurality of C-V converters may respectively be connected to a plurality of first electrodes of the first and second pressure sensors 1000. The plurality of C-V converters may convert the electrostatic capacitance into a voltage signal and output an analog signal, and to this end, each of the plurality of C-V converters may include an integration circuit which integrates the electrostatic capacitance. The integration circuit may integrate the electrostatic capacitance, convert the capacitance into a predetermined voltage, and output the voltage. Meanwhile, when a driving signal is sequentially applied to the plurality of second electrodes from the driving unit 6210, since the electrostatic capacitance may be detected from the plurality of first electrodes, the C-V converters of the number of the plurality of first electrodes may be provided.

The conversion unit 6230 converts the analog signal output from the detection unit 6220 into a digital signal and generates a detection signal. For example, the conversion unit 6230 may include: a time-to-digital converter (TDC) circuit which measures the time until the analog signal output from the detection unit 6220 reaches a predetermined reference voltage level and converts the time into a detection signal, as a digital signal; or an analog-to-digital (ADC) circuit which measures the amount of change in the level of the analog signal output from the detection unit 6220 for a predetermined time, and converts the amount into a detection signal, as a digital signal.

The calculation unit 6240 determines the touch pressure applied to the plurality of pressure sensors 1000 using the detection signal. The number, the coordinates, and the pressure of the touch input applied to the plurality of pressure sensors 1000 may be determined by using the detection signal. The detection signal which serves as a base for the calculation unit 6240 to determine the touch input may be the data in which the change in the electrostatic capacitance is digitized, and in particular, the data which indicates the difference in the electrostatic capacitance between the case in which a touch has not occurred and the case in which touch has occurred.

As such, touch inputs to the first and second complex devices 6000a and 6000b may be determined by using the control unit 6200, and this may be transmitted to, for example, a main control unit of a host 9000 of an electronic device or the like. That is, the control unit 6200 generates X- and Y-coordinate data and Z-pressure data using the signal input from the pressure sensors 1000 by using the detection unit 6220, the conversion unit 6230, the calculation unit 6240, etc. The X- and Y-coordinate data and Z-pressure data, which are generated as such, are transmitted to the host 9000, and the host 9000 detects, using, for example, a main controller, the touch and the pressure of the corresponding portion using the X- and Y-coordinate data and Z-pressure data.

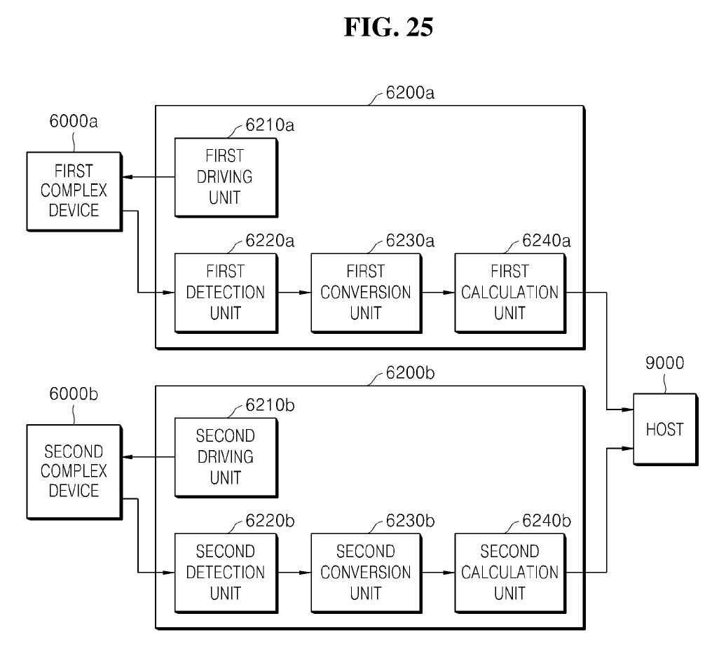

In addition, the control unit 6200 may include: a first control unit 6200a which processes the output of the first pressure sensor 2300; and a second control unit 2500b which processes the output of the second pressure sensor 6000. That is, FIG. 24 illustrates a single control unit 6200 which processes the outputs from the first and second complex devices 6000a and 6000b, but as illustrated in FIG. 25, the control unit 6200 may include first and second control units 6200a and 6200b which respectively process the outputs of the first and second complex devices 6000a and 6000b. Here, the first control unit 6200a may include a first drive part 6210a, a first detection unit 6220a, a first conversion unit 6230a and a first calculation unit 6240a, and the second control unit 2500a may include a second drive part 6210b, a second detection unit 6220b, a second conversion unit 6230b and a second calculation unit 6240b. Meanwhile, the first and second control units 6200a and 6200b may be implemented in integrated circuits (IC) different from each other. Accordingly, in order to process the outputs from the first and second complex devices 6000a and 6000b, two integrated circuits may be required. However, the first and second control units 6200a and 6200b may also be implemented in respective integrated circuits (IC) different from each other. Detailed description on the configurations and functions of these first and second control units 6200a and 6200b will not be provided because the outputs from the first and second complex devices 6000a and 6000b are respectively divided and processed by the first and second control units, and because the configurations and functions are the same as described above using FIG. 24.

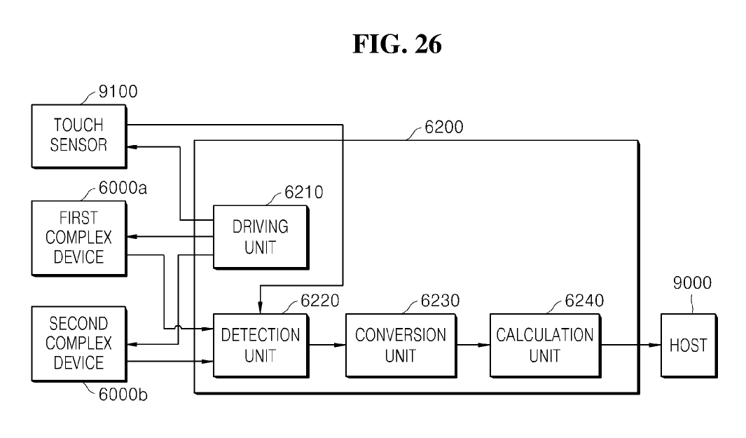

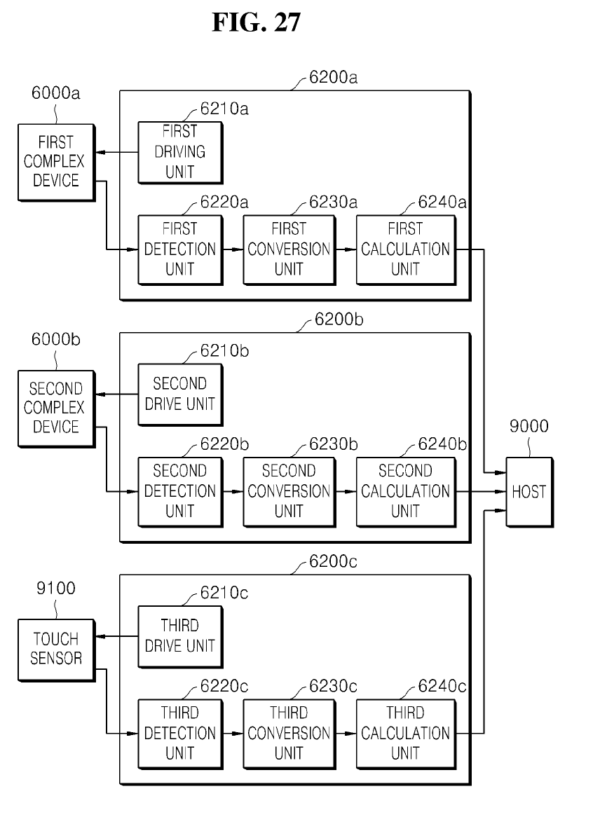

Meanwhile, the electronic device may also be further provided with a touch sensor besides at least one touch sensor of the first and second complex devices 6000a and 6000b. In this case, the operation of the touch sensors may be performed by a single control unit 6200 as illustrated in FIG. 26. That is, the single control unit 6200 may control the at least one of the first and second complex devices 6000a and 6000b and the single touch sensor 9100. In addition, when the touch sensor 9100 is further provided, as illustrated in FIG. 27, besides the first and second control units 6200a and 6200b for controlling the first and second complex devices 6000a and 6000b, a third control unit 6200c may further be provided. That is, in order to respectively control the first and second complex devices 6000a and 6000b and the touch sensor 9100, the plurality of control units may be provided.

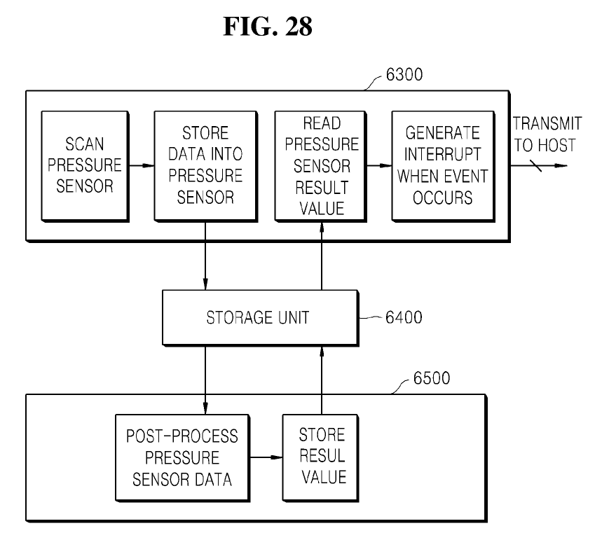

FIG. 28 is a bock diagram for describing a data processing method of a complex device in accordance with another exemplary embodiment, and for describing a data processing method of a pressure sensor inside the complex device.

As illustrated in FIG. 28, in order to process the data of a pressure sensor in accordance with another exemplary embodiment, a first control unit 6300, a storage unit 6400, and a second control unit 6500 may be provided. Such a configuration may be implemented on the same IC, or also be implemented on different ICs. In addition, the data processing of the exemplary embodiment may be performed by cooperation of the first control unit 6300 and the second control unit 6500. Here, the first and second control units 6300 and 6500 may be provided to process the data of respective pressure sensors. In addition, any one (for example, the first control unit) of the first and second control units 6300 and 6500 may be the control unit for controlling a touch sensor and the other one (for example, the second control unit) may be the control unit for controlling the pressure sensors. In this case, the control unit for controlling the touch sensor may simultaneously control the touch sensor and the pressure sensor. In addition, the storage unit 6400 serves as a data transmission path of the first control unit 6300 and the second control unit 6500 and functions to store the data of the first and second control parts 6300 and 6500.

As illustrated in FIG. 28, the first control unit 6300 scans the pressure sensors and stores the raw data of the pressure sensors into the storage unit 6400. The second control part 6500 receives data from the storage unit 6400, processes the pressure sensor data, and stores the result values into the storage unit 6400. The result values stored into the storage unit 6400 may include data such as Z-axis, states, etc. The first control unit 6300 reads the result value of the pressure sensor from the storage unit 6400, and then generates and transmits, to a host, an interrupt when an event occurs.

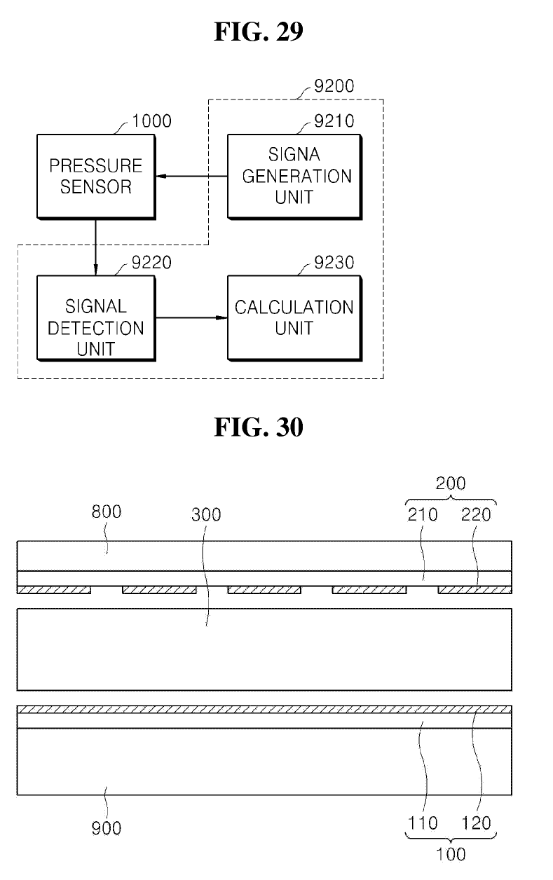

Meanwhile, as described above using FIGS. 20 to 22, the front surface input part 7360 of the electronic device 7000 may be configured from a fingerprint recognition sensor, and a pressure sensor in accordance with an exemplary embodiment may be used for the fingerprint recognition sensor. FIG. 29 is a configuration diagram of a fingerprint recognition sensor employing a pressure sensor in accordance with exemplary embodiments. In addition, FIG. 30 is a cross-sectional view of a pressure sensor in accordance with another exemplary embodiment.

Referring to FIG. 29, a fingerprint recognition sensor employing a pressure sensor in accordance with exemplary embodiments may include: a pressure sensor 1000; and a fingerprint detection unit 9200 which is electrically connected to the pressure sensor 1000 and detects a fingerprint. In addition, the fingerprint detection unit 9200 may include a signal generation unit 9210, a signal detection unit 9220, a calculation unit 9230, and the like.

Meanwhile, as illustrated in FIG. 30, the pressure sensor 1000 may further be provided with a protective layer 800 as a protective coating for the surface on which a finger is placed. The protective layer 800 may be manufactured by using urethane or another plastic which can function as a protective coating. The protective layer 800 is adhered to a second electrode layer 200 by using an adhesive. In addition, the pressure sensor 1000 may further include a support layer 900 which can be used as a support inside the pressure sensor 1000. The support layer 900 may be manufactured by using teflon or the like. Of course, instead of teflon, another type of supporting materials may be used for the support layer 900. The support layer 900 is adhered to a first electrode layer 100 by using an adhesive. Meanwhile, the pressure sensor 1000 of an exemplary embodiment may be provided with: a piezoelectric layer or dielectric layers 300 divided into unit cells spaced apart predetermined distances from each other in one direction and another directions by cutaway portions 330; and an elastic layer 400 formed in the cutaway portions 330. In this case, it is desirable that the elastic layer 400 prevent respective vibrations from affecting each other.

The fingerprint detection unit 9200 may be connected to each of the first and second electrodes 110 and 210 which are provided on and under the piezoelectric layer 300 or the dielectric layer 500 of the pressure sensor 1000. The fingerprint detection unit 9200 may generate an ultrasonic signal by vertically vibrating the piezoelectric layer 300 or the dielectric layer 500 by applying, to the first and second electrodes 110 and 210, a voltage having a resonant frequency of an ultrasonic band.

The signal generation unit 9210 is electrically connected to the plurality of first and second electrodes 110 and 210 which are included in the pressure sensor 1000, and applies, to each electrode, an alternating current voltage having a predetermined frequency. While the piezoelectric layer 300 or the dielectric layer 500 of the pressure sensor 1000 is vertically vibrated by the alternating current voltage applied to the electrodes, an ultrasonic signal having a predetermined resonant frequency, such as 10 MHz, is emitted to the outside.

A specific object may contact one surface on the pressure sensor 1000, for example, one surface of the protective layer 800. When the object contacting the one surface of the protective layer 800 is a human finger including a fingerprint, the reflective pattern of the ultrasonic signal emitted by the pressure sensor 1000 is differently determined according to the fine valleys and ridges which are present in the fingerprint. Assuming a case in which no object contacts a contact surface such as the one surface of the protective layer 800, most of the ultrasonic signal generated from the pressure sensor 1000 due to the difference in media between the contact surface and air cannot pass through the contact surface but is reflected and returned. Conversely, when a specific object including a fingerprint contacts the contact surface, a portion of the ultrasonic signal which is generated from the pressure sensor 1000 directly contacting the ridges of the fingerprint passes through the interface between the contact surface and the fingerprint, and only a portion of the generated ultrasonic signal is reflected and returned. As such, the strength of the reflected and returned ultrasonic signal may be determined according to the acoustic impedance of each material. Consequently, the signal detection unit 6920 measures, from the pressure sensor 1000, the difference in the acoustic impedance generated by the ultrasonic signal at the valleys and ridges of the fingerprint, and may determine whether the corresponding region is the sensor in contact with the ridges of the fingerprint.

The calculation unit 9230 analyzes the signal detected by the signal detection unit 9220 and calculates the fingerprint pattern. The pressure sensor 1000 in which a low-strength reflected signal is generated is the pressure sensor 1000 contacting the rides of the fingerprint, and the pressure sensor 1000 in which a high-strength signal is generated —ideally, the same strength as the strength of the output ultrasonic signal—is the pressure sensor 1000 corresponding to the valleys of the fingerprint. Accordingly, the fingerprint pattern may be calculated from the difference in the acoustic impedance detected from each region of the pressure sensor 1000.

The present invention may, however, be embodied in different forms and should not be construed as limited to the embodiments set forth herein. That is, the above embodiments are provided so that this invention will be thorough and complete, and will fully convey the scope of the present invention to those skilled in the art, and the scope of the present invention should be understood by the scopes of claims of the present application.

1. A complex device comprising:
a pressure sensor; and
at least one functional part having a different function from the pressure sensor.

2. (canceled)

3. The complex device of claim 1, wherein the pressure sensor comprises:
first and second electrode layers provided spaced apart from each other and comprising first and second electrodes; and
a piezoelectric layer or a dielectric layer provided between the first and second electrode layers.

4. The complex device of claim 3, wherein the piezoelectric layer comprises a plurality of plate-like piezoelectric bodies in a polymer.

5. The complex device of claim 3, wherein the piezoelectric layer comprises a plurality of cutaway portions formed with predetermined widths and depths.

6. The complex device of claim 5, further comprising an elastic layer provided inside the cutaway portions.

7. The complex device of claim 3, wherein the dielectric layer is compressible and restorable and comprises at least one of a material with a hardness of 10 or less, a plurality of dielectric bodies with a dielectric constant of 4 or more, and a plurality of pores.

8. The complex device of claim 7, wherein the dielectric layer further comprises a material for shielding and absorbing electromagnetic waves.

9. The complex device of claim 7, wherein the dielectric layer comprises the dielectric bodies which are formed in a content of 0.01% to 95% based on 100% of the dielectric layer.

10. The complex device of claim 7, wherein the dielectric layer has a porosity of 1% to 95%.

11. The complex device of claim 7, wherein the pores are formed in two or more sizes and at least one or more shapes.

12. The complex device of claim 7, wherein the dielectric layer has a smaller pore cross-sectional area ratio in a vertical cross-section thereof than in a horizontal cross-section thereof.

13. The complex device of claim 7, wherein the dielectric layer has at least one pore having a larger diameter in a horizontal direction than in a vertical direction.

14. The complex device of claim 7, wherein the dielectric layer has a dielectric constant of 2 to 20.

15. (canceled)

16. The complex device of claim 3, further comprising an insulating layer provided at least one among places on the first electrode layer, between the first and second electrode layers, and under the second electrode layer.

17. The complex device of claim 3, further comprising first and second connection patterns respectively provided on the first and second electrode layers and connected to each other.

18. The complex device of claim 1, wherein the pressure sensor enables the functional part.

19. The complex device of claim 1, wherein the functional part comprises:
a piezoelectric device provided on one side of the pressure sensor; and
a vibration plate provided on one side of the piezoelectric device.

20. (canceled)

21. The complex device of claim 1, wherein the functional part comprises at least one among an NFC, a WPC, and an MST which are provided on one side of the pressure sensor and each of which comprises at least one antenna pattern.

22. The complex device of claim 1, wherein the functional part comprises:
a piezoelectric device provided on one surface of the pressure sensor;
a vibration plate provided on one surface of the piezoelectric device; and
at least one among an NFC, a WPC, and an MST which are provided on the other surface of the pressure sensor or on one surface of the vibration plate.

23. The complex device of claim 1, comprising a fingerprint detection unit electrically connected to the pressure sensor and configured to measure, from the pressure sensor, a difference in acoustic impedance generated by an ultrasonic signal at valleys and ridges of a fingerprint and thereby detects the fingerprint.

24. (canceled)

25. (canceled)

26. (canceled)

27. (canceled)

28. (canceled)
